(19) United States
(12) Patent Application Publication
(10) Pub. No.: US 2006/0225579 A1
(43) Pub. Date: Oct. 12, 2006

(54) Food embossing and impressing device

(76) Inventor: Richard Ben Errera, Ronkonkoma, NY (US)

Correspondence Address: ALFRED M. WALKER, 225 OLD COUNTRY ROAD, MELVILLE, NY, 11747-2712, US

(21) Appl. No.: 11/447,216

(22) Filed: Jun. 5, 2006

Related U.S. Application Data
(63) Continuation-in-part of application No. 11/068,275, filed on Feb. 28, 2005.
Application No. 11/068,275 is a continuation-in-part of application No. 10/423,562, filed on Apr. 25, 2003.
Application No. 11/068,275 is a continuation-in-part of application No. 10/404,376, filed on Apr. 1, 2003.
Application No. 11/068,275 is a continuation-in-part of application No. 10/634,438, filed on Aug. 5, 2003.
Application No. 11/068,275 is a continuation-in-part of application No. 10/634,439, filed on Aug. 5, 2003, now Pat. No. 6,990,892.
(60) Provisional application No. 60/802,481, filed on May 22, 2006.

(51) Int. Cl. A47J 37/08

(52) U.S. Cl. 99/388

(57) ABSTRACT

A device for impressing and embossing food items for both commercial and home use wherein the impressed and embossed images are interchangeable, allowing the user to form a pattern as desired.

### RELATED APPLICATIONS

This application is a continuation-in-part of application Ser. No. 11/068,275 filed Feb. 28, 2005, which was a continuation-in-part of the application entitled Food Embossing Roller Device, the specification of which was filed on Apr. 25, 2003 as application Ser. No. 10/423,562; also the application entitled Food Embossing Stamper Device, the specification of which was filed on Apr. 1, 2003 as application Ser. No. 10/404,376; the application entitled Enhanced Food Embossing Roller Device, the specification of which was filed on Aug. 5, 2003 as application Ser. No. 10/634,438 and the application entitled Enhanced Food Embossing Stamper Device, the specification of which was filed on Aug. 5, 2003 as application Ser. No. 10/634,439. This application also claims benefit under 35 USC 119(e) from provisional application No. 60/406,448 of Aug. 28, 2002 and from provisional application Ser. No. 60/802,481 of May 22, 2006.

### FIELD OF THE INVENTION

The present disclosure relates to a device which forms raised/embossed or impressed forms in the surface of foods, such as a pizzeria name or logo.

### BACKGROUND OF THE INVENTION

Commercial and home cooks often decorate food surfaces for formal dinners, birthdays and special occasions. Foods may be decorated with edible flowers, icing, coloring tubes for writing of a sugar based paste, and/or edible wafers having images of photographs.

A number of known devices are designed to form a pattern, design or silhouette in food while the device also cooks the food, such as, for example, U.S. Pat. No. 5,996,476 to Schultz; U.S. Pat. No. 5,642,659 to Seasona et al., and U.S. Pat. No. 5,789,009, invented by Kordic et al. The patent to Mosby et al., U.S. Pat. No. 4,656,927, describes a device for producing designs on a slice of bread during toasting by shielding the bread in the shape of the design from the heat and thereby forming an image on the surface of the bread. Fiorenza, U.S. Pat. No. 4,290,349, discloses a toaster accessory which is dimensioned to fit a pre-made sandwich into a conventional toaster and optionally form decorative designs with inserts panels.

Other devices produce edible decorations which may be placed on food surfaces as desired, see, for example, U.S. Pat. No. 6,242,026 to Feeley. Alternatively, U.S. Pat. No. 4,578,273 to Krubert discloses a method of forming a hard, non-porous icing surface by drying an icing mixture and printing one or more edible inks on the icing using a printing pad having an edible silicone oil. The Quinlivan patent, U.S. Pat. No. 4,285,978, discloses a method of transferring decorative designs onto baked goods by transferring a pre-printed design from a transfer material to an uncooked dough surface. Macpherson et al., in U.S. Pat. No. 5,017,394, describe a method of using a silk screen to form thin, flat, flexible, free standing base shapes or transfers directly on release paper to produce the final edible image for decorating foodstuffs. Ahn, U.S. Pat. No. 5,834,047, discloses a method of imprinting shapes of multiple colors inside confectionery products with edible ink.

U.S. Pat. No. 5,992,305, to Naivar describes a device that forms char marks to mimic a grill pattern on the surface of foods.

Older devices are known which may shape and cut dough foods such as, for example, an elongate rolling pin designed to roll and cut dough into long strips, a rolling pin designed to cut dough into shapes rather than using individual cookie cutters, and a rolling pin designed to form ravioli by pinching two layers of dough together at preset intervals after filing had been placed between the layers. See, U.S. Pat. No. 522,465 to Goodnough; U.S. Pat. No. 2,099,286 to Usbeck; and U.S. Pat. No. 2,075,157 to Alberti, respectively. Additionally, a U.S. patent to Blaul, 177,319, discloses a rolling pin having a permanently affixed intaglio, or engraved/carved, pattern to form shapes in the dough.

Also known is a dual rolling pin device having two rolling pins in the same plane and container means located above the rolling pins to emit flour over the surface of the rolling pins to prevent dough from sticking to the pins while in use. See, U.S. Pat. No. 4,426,200 to Miller.

Frequently, writing is desired on various foodstuffs where the use of icing or a sugar base paste is undesirable. Therefore, an alternative device would be useful for marking foods on special occasions or, for example, re-enforcing the name of a pizzeria or bakery on pizza or breadsticks. Therefore, it would be advantageous to provide a device to mark foods.

### SUMMARY OF THE INVENTION

This disclosure relates to a device for impressing and embossing food surfaces having interchangeable images. The device includes a housing, a carrier for image-producing letter blocks, message bands and message strips that are removably attached to the housing, a letter block removably attached to the carrier, a message band removably attached to the carrier and a message strip that is removably attached to the carrier. The interchangeable images are selected from the group consisting essentially of letters, numbers, words, pictures and punctuation marks.

In one embodiment, a decorating wheel for impressing and embossing images on food surfaces includes a semi-circular housing; a circular decorating wheel removably attached to the housing; letter blocks removably attached to the decorating wheel, a message strip removably attached to the decorating wheel; and a message band removably attached to the decorating wheel.

In one embodiment, a decorating stamper for impressing and embossing images on food surfaces includes a generally rectangular housing; a handle portion attached to an upper surface of the housing; a depth adjuster knob attached to an upper portion of the handle portion; an engaging column attached to a lower portion of the housing; a spring attached to the engaging column; a message plate attached to the lower portion of the housing; and a message strip removably attached to the message plate.

In one embodiment, a device for impressing and embossing images onto a food product includes a decorating wheel having at least one food contact surface extending therefrom. The decorating wheel is rotatably movable about an axle, within a housing with a right housing half and a left housing half forming the housing. An attachment mechanism for quickly and removably attaching the decorating wheel to the housing, and a hole for attachment of optional coloring modules, the housing being shell-shaped; the housing being self-standing on a work surface by resting on a forward edge of the housing; the decorating wheel being removably attached to the housing: the decorating wheel rotating about an approximately central axis located through the cross-sectional plane of the decorating wheel.

In one embodiment, a device for impressing and embossing images upon food products includes a stamper pad enclosed within a vertically movable housing, the vertically movable housing having a handle extending therefrom; a depth adjuster knob, and a base ring covering and protecting a lower portion of the housing, wherein by temporarily removing the base ring, an exposed lower portion of the housing frames and cuts through a food work surface around an impressed and/or embossed image. The stamper pad includes a message plate, the message plate accepting removably attaching an at least one of an image and block a message strips or a pre-formed message on an interchangeable message plate; the stamper pad having an engaging column, a spring, a housing, a handle and the depth adjuster knob; the message plate being pressed into contact with the food contact surface to form the image.

In an alternate embodiment of the food roller decorating wheel, it is configured as a two-part roller assembly in which a top flange ring removably snaps onto a lower portion which includes spokes, an axle hub and a lower flange ring. In practice, this configuration is easier to clean.

Several alternate embodiments of the housing for the decorating wheel are also described.

One alternative housing includes two snap-together mirror-image halves, with an extended handle providing a comfortable neutral wrist position.

Another housing variation includes a handle with two hinged clam shell halves; this is easy to clean and provides simple wheel access.

Another housing is one-piece with no separate handle; the decorating wheel just snaps in from below by prying the roller hub extensions apart. A second one-piece housing uses a push-button operated wheel attachment which permits one-handed roller operation.

Alternate embodiments of the decorating stamper are also presented. One single-line stamper includes a main body which can made of a profile extrusion in either metal or plastic resin. A variation of this stamper is a side-stackable multi-line stamper with a handle assembly attached to two or more single line message handlers.

A phrase snap-on piece of semi-rigid plastic resin has a fixed message, which can be snapped onto a single-line or multi-line stamper.

Flexible decorating roller wheel and stamper imprinted phrases are defined with two types of attachment features. One type has attachment features molded adjacent to the beginning and the end of the flexible phrase strip. A second embodiment has attachment tabs with living hinges attached along the entire phrase strip.

For a cleaner, unclogged food decorating device, vented letters for imprinting are provided, which have an open back on any enclosed sections of a letter; even non-enclosed sections such as the inside of a “C” or a “G” would be vented. These debris venting letters are designed to be snapped onto a decorating wheel or stamper, to form decorating messages to be imprinted. If the support structures for these vented letters have openings that communicate with (for example, behind) the vent openings in the letters, any accumulated debris can just be pushed out in use. Also, the debris venting eliminates the build-up of pressure on entering the food item and the vacuum when emerging from the food item, which may tend to distort the letter. The two-part decorating wheel already has the requisite opening behind the snap-on vented letters, since the flanges are separated from each other by spokes which also have side openings to permit the flow of debris therethrough.

With regards to the food decorating stampers, a vented single-line stamper, as well as a vented multi-line stamper embodiment, is defined for optimal use with these vented letters.

Sometimes the food to be imprinted is hot, so it is beneficial to use an elongated wand to keep the user's hand away from the heat of the food being imprinted. For example, a wand is defined as a means to imprint initials or a logo onto hot food in the process of being cooked. It includes a long shaft with a thermally insulated handle at one distal end and a branding head at the other. The branding head and long shaft are heat resistant and preferably made of metal. The end of the branding head is either highly polished or treated with a non-stick coating (such as TEFLON®). It is used like a branding iron; except it is the food, as opposed to the iron, that is hot.

In an alternate embodiment, the wand has a hinged end piece which can be snapped and locked to bend at different angles to the main shaft. This has advantages for different uses. A pizza baker for example, would prefer using a 45 degree angle, thereby allowing easier impressing or embossing on a pizza pie already in the oven. A cook might prefer a 30 degree angle if impressing on a stove. Another feature of the wand is compatibility with the use of snap-on/off letters, designs logos or phrase pieces as used on the stampers or decorating wheel; they would have to be made of a heat resistant material.

Sets of tongs, in a variety of sizes, are used to imprint messages or decorative shapes onto spherically shaped foods, such as ice-cream, ices, sherbet, melon, meat, butter, margarine, cream cheese, matzo, or vegetables. The sets of tongs have two or more firm but springy circular arc tines, that move simultaneously from an open position to a closed position, thereby capturing the food item and simultaneously imprinting the desired design embossed onto the inside of the tines. The desired message is either embossed directly on the tine inner surface or onto a flexible sleeve that is slipped onto each tine prior to use.

In an alternate embodiment, the sets of tongs are configured in the general shape of food serving tongs with two or more circular arc tines emerging from the distal ends. The rigid (but slightly springy) tines have a crossectional shape compatible with the letters, designs, logos, and phrase pieces that are also usable on the decorating wheel or stampers. These sets of tongs can be used either for horizontal decorating (lines of latitude) or vertical decorating (lines of longitude) on spherical food items. Since the user has complete control of the imprinting/embossing force with this tong embodiment, food items which are not exactly spherical can be “molded” in the vicinity of the tines to achieve the imprint desired.

In yet another embodiment of the sets of tongs, they are configured in the general shape of a pair of scissors.

To prevent crushing of soft food, an optional feature is added to each of the three sets of tongs' embodiments to create an adjustable hard stop, limiting the degree to which the end effectors of the sets of tongs can close upon a food item. This would prevent accidentally mashing some food items. The feature may take the form of an adjustable cam on the first embodiment and an adjustable threaded cylinder on the second and third embodiments.

An embodiment of the roller using snap-on letters and symbols with their identifications printed on their upper side surfaces is presented. To enhance the usability of this feature, the housing of the roller is fitted with a semicircular window or cut-out to reveal these identifications which would have been otherwise obscured by the sides of the housing. The actual implementation could alternatively have a number of separate windows in a semicircular array with narrow web areas between to enhance the strength and rigidity of the roller housing with respect to a housing with a single long window. An alternate implementation would have a single wide semicircular window with glazing of transparent plastic to permit visibility while not compromising strength. A transparent housing is another alternative.

An embodiment of the roller using snap-on letters and symbols with their identifications printed on their upper side surfaces is presented. To enhance the usability of this feature, the housing of the roller is fitted with a semicircular window or cut-out to reveal these identifications which would have been otherwise obscured by the sides of the housing. The actual implementation could alternatively have a number of separate windows in a semicircular array with narrow web areas between to enhance the strength and rigidity of the roller housing with respect to a housing with a single long window. An alternate implementation would have a single wide semicircular window with glazing of transparent plastic to permit visibility while not compromising strength. A transparent housing is another alternative.

An optional food coloring tube is also part of this invention. It has a tubular reservoir with a sponge or wisk brush roller at its lower distal end for spreading fluid from the reservoir onto a food item to be embossed or imprinted by the roller and stamper. If the reservoir is filled with olive oil instead of food coloring, the treated area (such as pizza dough) will add a deep luster with improved flavor after baking. For convenience of use the tube is simply clipped onto or off the housing of a roller or the frame of a stamper equipped with a spring clip to receive the reservoir tube. The roller or stamper is tilted to cause the sponge or brush roller of this accessory to make contact with the food item and lay down a stripe roughly the width of the area to be imprinted or embossed.

A special stamper to place imprinted or embossed messages or decoration on the top of raised food items is called the “Crown Me™” tool. It is ideally suited to decorate ball shaped food items such as ice cream, meat balls, butter balls, cheese balls or matzo balls. It can also be used to decorate small buns, small round, square or rectangular cheeses, cheese wedges, and so forth. With a “stamping pad” type mechanism and an internal sponge or pad, a message plate is first loaded with the desired item (on the sponge or pad) and is then inverted and contacted to the food item in one motion by pressing a knob on top. The stamper mechanism itself is attached to a hollow cylinder or truncated cone base which contains the food item and spaces the top surface of the food item an appropriate distance from the bottom of the stamper. The stamper mechanism can be snapped off the base and used to stamp flat food items as well. It is advantageous to mold the base of a transparent plastic resin to enhance the ease of targeting the desired food item area. The Crown Me™ tool can add coloring, syrup, spices, fragrance, olive oil, or even powdered sugar to a food item during the imprinting step.

An alternate embodiment of ingredient transferring stamper is more economical to manufacture than those discussed above which include a “stamping pad” type mechanism inverting the imprinting or embossing surface during operation. It includes a simple stamper which can be used for stamping without ingredient transferring and a matching container which holds a pad or sponge used to contain ingredients such as powdered sugar, spices, or any number of liquids from food coloring to flavors to oils or fragrances. In operation, the stamper of this embodiment is simply placed on top of the pad or sponge thereby transferring ingredients onto the embossing/imprinting surface prior to contacting the food item. The stamper itself includes a hollow housing with a snap-on base plate with rectangular openings which can accept either a message plate or individual snap-in letters. The ingredient container with sponge or pad can also be sized to be compatible with an earlier embodiment of stamper with a depth control feature; thus the earlier embodiment would be converted into an ingredient transferring stamper.

### DESCRIPTION OF THE DRAWINGS

The present disclosure can best be understood in connection with the accompanying drawings. It is noted that the invention is not limited to the precise embodiments shown in drawings, in which:

FIG. 1 is a perspective view of a decorating wheel embodiment of the device.

FIG. 2 is a perspective, exploded view of a decorating wheel embodiment of the device.

FIG. 3 is a perspective view of the decorating wheel embodiment depicted potential attachment locations for letter blocks, message strip and message bands.

FIG. 4 is a perspective view of a reversible impressing/embossing block for letters, number or other images.

FIG. 5 is a perspective view of a reversible impressing/embossing block having edges curved upward or above the plane of the image-forming block.

FIG. 6 is a perspective view of a reversible impressing/embossing block with edges curved downward from or angled away from the plane of the image-forming block.

FIG. 7 is a side view detail of a letter block engaged with decorating wheel.

FIG. 8 is a top view of flexible message strip.

FIG. 9 is a side edge view of flexible message strip of FIG. 8.

FIG. 10. is a perspective view, in detail, of elastomeric band with compatible letter blocks of an alternate embodiment.

FIG. 11 is a perspective view of dual-sided elastomeric message band.

FIG. 12 is a side schematic view showing location of optional color/oil rollers.

FIG. 13 is a detailed view of an embossed message on dough in three different colors.

FIG. 14 is a perspective view of the decorating stamper embodiment of the device.

FIG. 15 is a perspective, exploded view of the decorating stamper embodiment of the device.

FIG. 16 is a bottom view of impression/embossing plate with message.

FIG. 17 is an impression/embossing plate accepting rectangular strips compatible with letter blocks of FIGS. 4-6.

FIG. 18 is a side schematic view of alternate decorating stamper embodiment of the device with built-in fluid pad-upper position.

FIG. 19 is a side view schematic during inversion of message plate.

FIG. 20 is a side view schematic with message plate down.

FIG. 21 is a perspective exploded view of a two-part decorating wheel.

FIG. 22 is a perspective view of a two-part wheel housing with an extended handle.

FIG. 23 is a perspective view of a clam shell wheel housing with a handle.

FIG. 24 is an end view of a one-piece housing with a snap-in decorating wheel attachment.

FIG. 25 is a perspective view of a one-piece housing with a push button wheel attachment and detachment.

FIG. 26 is a perspective view of a single-line stamper.

FIG. 27 is a perspective view of a stacked multi-line stamper.

FIG. 28 is a perspective view of a semi-rigid phrase snap-on piece.

FIG. 29 is a perspective view of two embodiments of flexible decorative phrase strips usable by a roller decorating wheel or by stampers.

FIG. 30 is a perspective view of a vented letter used for forming impressions in food.

FIG. 31 is a perspective view of a decorating wheel with vented letters attached, illustrating the path for clearing of any debris which may be trapped within the letters.

FIG. 32 is a perspective view of a vented single-line stamper usable with vented letters.

FIG. 33 is a perspective view of a vented multi-line stamper.

FIG. 34 is a perspective view of a wand for marking hot food as it is being cooked.

FIG. 35 is a perspective view of the wand of FIG. 34 in use.

FIG. 36 is a perspective view of an alternate embodiment for a hot food embossing/impressing wand with a hinged end piece.

FIG. 37 is a perspective view of a three-tine set of sets of tongs in the open position for decorating spherical food items.

FIG. 38 is a perspective view of the sets of tongs of FIG. 36 capturing and imprinting a spherical food item.

FIG. 39 is a side view detail in partial crossection showing the mechanism of the sets of tongs of FIGS. 36 and 37.

FIG. 40 is a perspective view of an alternate embodiment for a set of tongs with four tines and a different configuration.

FIG. 41 is a perspective view of the set of tongs of FIG. 40 being used for a horizontal impression/embossing.

FIG. 42 is a perspective view of the set of tongs of FIG. 40 being used for a vertical impression/embossing.

FIG. 43 is a perspective view of the third embodiment of a set of tongs, being provided in the general shape of a pair of scissors.

FIG. 44 is a side crossectional elevational view of an adjustable hard stop movement limiting feature for the first embodiment of the set of tongs, to prevent mashing of soft food.

FIG. 45 is a an external perspective view of the first embodiment of a set of tongs, showing the added hard stop movement limiting adjusting knob.

FIG. 46 is a perspective detail of the hard stop movement limiting feature for the second and third embodiments of sets of tongs.

FIG. 47 is a perspective view of the movement limiting feature of FIG. 46 having been added to the second embodiment for a set of tongs.

FIG. 48 is a perspective detail of the movement limiting feature of FIG. 46 added to the third embodiment for a set of tongs.

FIG. 49 is a side elevation of a roller embodiment using snap-on letters with side identifications and windows in the housing to permit their viewing through the housing.

FIG. 50 is a side elevation of a roller similar to that of FIG. 49 but with a single wide window in the housing sides.

FIG. 51 is a perspective view of another embodiment of handle for use on rollers and stampers of this invention.

FIG. 52 is a side elevation of a roller using the handle of FIG. 51 in an attitude poised for use.

FIG. 53 is a side elevation of the roller of FIG. 52 tilted up and resting on a wing of the handle shown in FIG. 51.

FIG. 54 is a side elevation of a stamper of this invention using the handle of FIG. 51.

FIG. 55 is a perspective exploded view of a food coloring tube accessory of this invention.

FIG. 56 is a side elevation of the food coloring tube attached to a roller housing.

FIG. 57 is a side elevation of the food coloring tube attached to the frame of a stamper.

FIG. 58 is a perspective view of a special stamper (Crown Me™ tool) for small raised food items.

FIG. 59 is a top elevation of the stamper plate which receives snap-in letters or message plates for use with the stamper of FIG. 58.

FIG. 60 is a perspective view of another embodiment of ingredient transferring stamper of this invention.

FIG. 61 is an exploded view of the components comprising the stamper shown in FIG. 60.

### DETAILED DESCRIPTION

This disclosure relates to a device that forms raised, i.e. embossed, and/or impressed words, letters, messages, designs, and images safely into foods, including fruits and doughs, as decoration and/or advertising. The device is hand-held and useful in both commercial and home settings for providing words, messages, phrases, in combination with images if desired, to any malleable food surface. The device may be embodied in a convenient decorating wheel shape to etch or form messages into circular food surfaces, such as piecrust or pizza crust. The decorating wheel format quickly and easily forms a contiguous message around a circumferential food surface, unlike a wider device, such as a rolling pin, which has an elongate shape and could not be rolled to easily follow a circumferential edge without impinging on a larger area of the food surface, and perhaps misshaping the rest of the food surface. The device may also be embodied in a hand-held decorating stamper form. These messages may be used, for example, as advertisement on pizza, rolls and/or other foods to denote the merchant. Additionally, the messages could be added for use on specific occasions, such as a birthday, a name day, a celebrated holiday or a party. The device can form words and messages to suit, according to the business and/or occasion at hand, as well as spell out names, dates and forms images such as faces, hearts, sun and moon, other patterns, and the like. The words and messages can be spelled in any language with or without images and/or dates interspersed in the words of the message with interchangeable dies having contact surfaces that form raised or impressed letters, words or images. For example, a restaurant may impress or raise/emboss words such as “Pizza Italia” around the crust of all pizzas sold, a bakery may impress or raise/emboss words such as “Broadway Bakery” or “Best Breads”, or a caterer may impress or raise words such as a bride and grooms names or the date of a wedding, the name of a company or organization holding a function, or the name of a fund raising event in fruits, bread, pastries or other foods. The words, messages and images may be customized as desired with interchangeable letters, numbers, and images. Pre-set messages and words may also be used in conjunction with the device to form frequently used sayings such as “Happy Birthday” or “Happy Anniversary”. Any desired message may be enhanced with the use of a coloring cartridge, which may be filled with any edible substance that will color the raised or impressed letters. For the purposes of this application, the term “image” is defined as including letters, words, numbers, symbols, and the like.

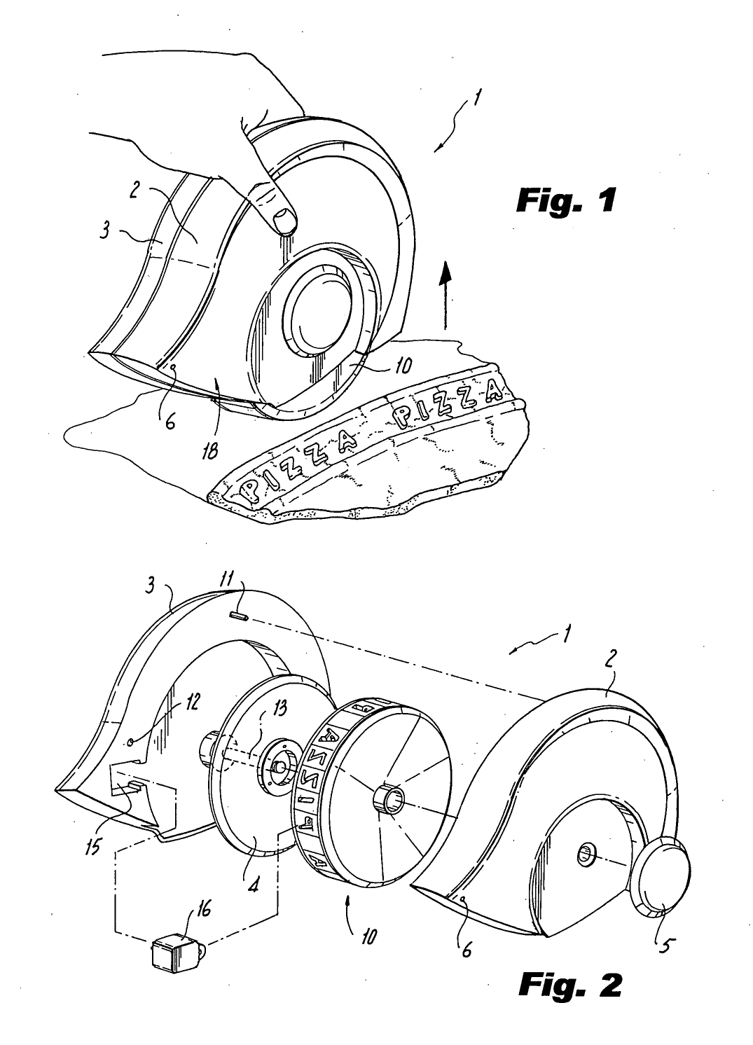

Referring to FIG. 1, there is shown a perspective view of the device in a roller embodiment, which includes a right housing half 2 and a left housing half 3 forming a housing 18, an attachment mechanism 5 for quickly and removably attaching a decorating wheel 10, which acts as a carrier for image-producing letter blocks, message band and message strips, to the housing, and hole 6 for attachment of optional coloring modules. The housing 18 is generally semi-circular in silhouette, or “shell-shaped”, and can include grooves, which lie approximately parallel to the cross-sectional plane of the decorating wheel 10. The grooves of the housing 18 can be formed for ergonomic comfort of the user. The housing 18 can be formed to be self-standing on a work surface by resting on a forward edge of the housing. The decorating wheel 10 is removably attached to the housing 18 and can be clipped on, screwed on, snapped on, or the like, to allow the decorating wheel 10 to rotate about an approximately central axis located through the cross-sectional plane of the decorating wheel 10.

Referring to FIG. 2, an exploded view of the housing 18 having a decorating wheel 10 and axle 13 with locking groove near distal end rigidly attached to a left housing half 3. A coloring cartridge module 16 including a reservoir for a coloring substance and an application wheel is shown. The coloring cartridge module 16 functions as a reservoir for edible food coloring substances such as food dye, olive oil, colored sugars and the like. The food coloring substances can be released from the coloring cartridge module 16 and is spread on the decorating wheel 10 by an applicator, such as a wheel, small brush, felt or other washable material which can wipe the food coloring substances onto the decorating wheel 10 as it rotates passed the coloring cartridge module 16. The optional coloring cartridge module 16 correlates with cavity 15 in the left housing half 3 for securely holding the coloring cartridge module 16 in its desired location where the wheel portion of the coloring cartridge module 22 can contact the periphery of the food contact surface of the decorating wheel 10.

The fastener means may include fasteners, such as for example, an alignment hole 12 and the alignment peg 11 which each function to securely hold the housing halves together by correlating with a mirror-image feature located on the right housing half 2 during assembly, i.e. a peg (not shown) inserts into alignment hole 12 and a hole (not shown) to accept the insertion of alignment peg 11. An optional cutting blade 4 is shown for trimming food stuffs as it is impressed and/or embossed, and is removably attached to the housing 18. An optional non-sharpened guide wheel (not shown) having blunt edges and approximately the same size as the optional cutting blade 4, can be removably attached to the housing 18 and used to adjust the depth of the impressing/embossing of the decorating wheel 10. The guide wheel can also assist in aligning the desired image with an edge or line in the food surface.

In one embodiment, the interchangeable decorating wheel 10 may have different diameters to easily accommodate varying dimensions of food work surfaces. For example, it may be desirable to employ a decorating wheel 10 with a comparatively small diameter on a pastry, for example, as compared to a decorating wheel 10 which may be used to impress or raise letter or images on a pizza or calzone crust. The size of the housing 18 may be formed to accommodate rollers of different diameters, such that smaller and larger diameter rollers can effectively rotate while removably attached to the housing 18.

In another embodiment, rollers of varying diameters may be removably attached to the housing 18 with fasteners, such as snap-on, clip-on, screw-on or other means along different optional locations in the housing 18 to allow effective rotate and function of small diameter rollers, with respect to the size of the housing 18. In such an embodiment, the housing 18 may include a plurality of decorating wheel attachment cites which can accommodate varying decorating wheel diameters.

In an alternative embodiment, two or more narrow rollers 10 may be removably attached to the housing 18 for concurrent use on a food surface to impress and/or emboss the same or different messages in a somewhat parallel format.

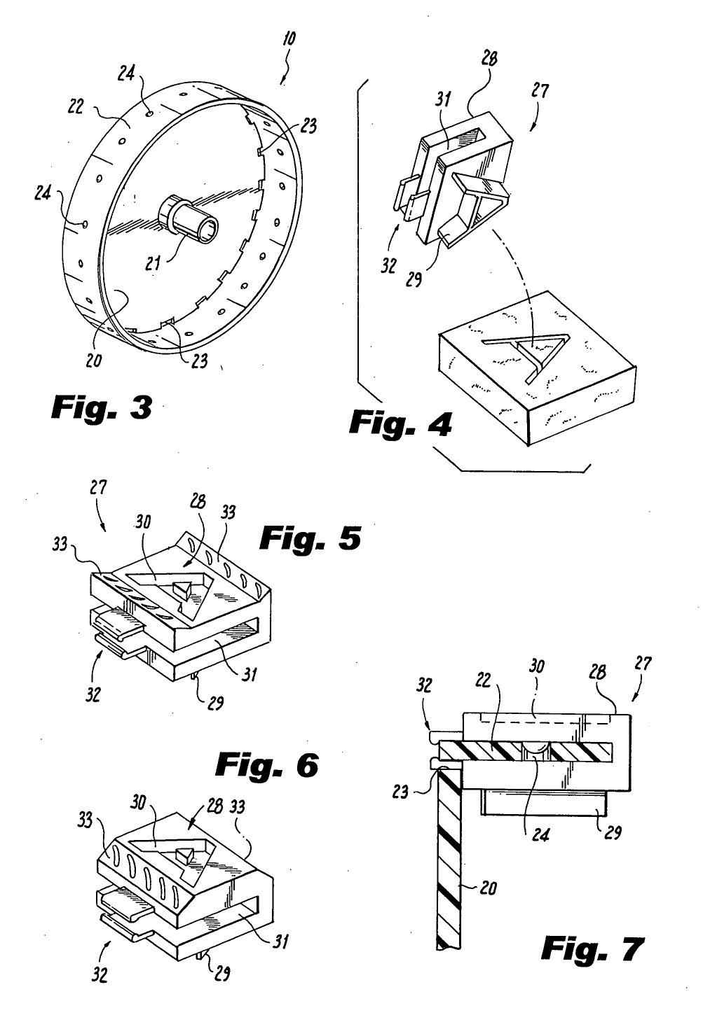

Referring to FIG. 3, the decorating wheel 10 is shown having a preferable flange 20 and having an attaching rim 22 where the letter blocks 27 and the rim 22 are orientated towards the food work surface. The flange 20 is generally circular and meets the rim 22 in a generally and preferably perpendicular fashion along the circumference of the flange 20. The flange 20 provides a mechanical connection between an axle bearing and spacer 21. The flange 20 has a series of regularly positioned one or more rectangular slots 23 at the junction of rim 22 into which a block 27 may snap or slide to form any desired message or image to be impressed and/or embossed/raised into a food surface. The rim 22 also includes a number of regularly spaced one or more holes to accept a message strip or message band and prevent slipping of the strip or band while in use.

The flange 20 may include a plurality of slots 23 to allow the insertion of a plurality of blocks 27 as desired, to spell out any word or message that may be required and/or images, as desired. The blocks 27 may be formed of varying widths, with respect to the width of the decorating wheel 10, and can align with the pre-determined location of the slots 23. The interchangeable, multi-use, and re-arrangeable nature of the blocks 27 allow an infinite number of different messages or combinations of words to be impressed and/or raised/embossed in to a food surface as an occasion demands, and may then be changed for the following occasion.

The block 27 may be formed to impress any indicia, such as a letter, numbers, words, pictures, punctuation marks, or image (hereinafter referred to collectively as “letters”) into a food surface, or the block 27 may be formed to produce raised/embossed indicia, such as letters, numbers or images, i.e. the block may form embossments on food surfaces. The blocks 27 may be formed of any sturdy materials for use with foods, such as, for example, plastics which can be molded or cast into shapes, metals such as copper, aluminum, and steel, and hard woods. The images may also be optionally fixedly attached to the surface of a letter block. The impressing and embossing portion of the block 27 may include an angle draft of 0.5% to 10%, typically 2% to 4%, in difference between the upper and lower walls of the that impressing or embossing portion. The blocks 27 may be formed to be doubled sided, having the same letter in both sides or surface of the block, the same letter in upper and lower case, having frequently used letters and additional vowels on one side to easily customize any word or message, and/or the same letter, number or image having impressing forms on one side and raised/embossing forms on the opposite side. In an alternative embodiment, the block may have an image on one side or surface of the block and the image may be impressing or embossing.

Referring to FIG. 4, a letter block or block 27 includes a slot 31, latch extensions 32, a flat food contact surface 28 with the edge 33 which may include optional side impressing or raising/embossing decoration, a letter impression 29, and same letter carved out below the contact surface to form a raised or embossed form 30 on the opposite surface. The latch extensions 32 snaps into the rectangular slots 23 of the rim 22 while the rim 22 slides into the slot 31 for added stability during use. Once the desired letter block 27 are chosen and mounted on the rim 22, it can be moved over a food surface to spell/form any message. The resulting pattern of the food surface is dependant on whether the impressing 29 or embossing 30 side of the block 27 is positioned to face and interact with the food surface. The block 27, as shown in its impressing form in FIG. 4, includes a form of the particular letter that can be forced or pushed into the food surface and leave an impression of that letter in the food. The form of the letter on the impressing block 27 is raised above the food contact surface of the decorating wheel 10 or above the surface of a band 51 (as shown in FIG. 10), if such is used, approximately ¼ of an inch or more, although a slightly less raised letter form would also be legible, to impress a sufficiently deep letter form and allow the letter to be legible. The decorating wheel 10 is pushed along the food work surface to allow each letter block 27, in turn, to come in contact with the food surface and form or spell the desired message or image and the message may be repeated as desired.

To form raised letters or images, the block 27 includes the form of the indicia, such as a letter, numbers, words, pictures, punctuation marks, or image cut or carved into the block's 27 initially, substantially flat food contact surface below the surface of the block 27 material. The block 27 material can be carved to a depth sufficient to force the foodstuff of the food work surface up into the carved out form of a letter or image while applying the decorating wheel to the food work surface. The block 27 material may be carved out to a depth of approximately ¼ of an inch or more to allow sufficient dough to be forced upward into a raised pattern and substantially hold that pattern after cooking or baking, although a slightly more shallow depth will form a pattern as well.

The food contact surface of the block 27 that forms raised letters includes an uncut portion surrounding the carved out portion. These uncut portions of the block 27 food contact surface can form the edges around the carved out portion and can provide contact force to the food surface. The edges may be formed in a width approximately in the range of as wide as the carved out portion, in toto, to as wide as the carved out portion of the block 27 on each side of the carved out pattern. These edges help force the food dough into the cutout and smooth out the surrounding area to give the letter or other image, a noticeable raised, relief pattern.

The edges of the block 27 food contacts surface surrounding the carved out portion may be slightly ridged with respect to the depth of the carved out portion. The ridges can assist to spread out the food surface evenly without leaving ridge mark that noticeably remain after the cooking/baking process. When used with other foods, such as fruits, the consistency of the individual fruit can determine whether ridge marks might be more noticeable. In another embodiment, the edges may be mostly slightly ridged or flat, and include a deliberate pattern along the outer most portion of the edge of the block 27. Such patterns may include, for example, a scroll, a floral chain, a wave pattern, and the like.

As shown in FIG. 5, raised or embossed letter block 27 may be formed in an alternative pattern to assist in the movement of dough or food in to the letter form 29. The edges of the food contact surface 28 of the block 27 may be curved upward, or above, the food contact surface of the block 27 with respect to the block area surrounding the image. Such curved upward edges 33 can assist in pushing dough or other food stuffs into the carved out portion of the block 27, as well as forming an ornamental design along the edges where desired. This block 27 having curved upward edges 33 attaches to the decorating wheel 10 by sliding the slot 31 over the rim 22 to allow the latch extensions 32 to latch onto the rectangular slots 23 of the rim 22. The block 27 can then be used in conjunction with the decorating wheel 10 to form any message. Note that the block 27 is doubled sided and includes an impressing letter 30 on an opposite side.

Referring to FIG. 6, a block 27 is depicted having a alternative whereby surface 28 is above edges 33 which slope or curve downward with respect to the area of the block contact surface surrounding the image. A block 27 which forms raised or embossed letters may include the edges 33 of block 27 food contact surface 28 which are curved away from, or curved downward with respect to the food contact surface of the block. The curved away edges can assist in forcing dough or other food stuff into the carved out portion of the block 27 and smoothing out the surrounding food surface. The edges 33 may also be used to form a pattern which outlines the letters formed. Note that the block 27 is doubled sided and includes an impressing letter 30 on an opposite side.

Referring to FIG. 7, depicted is the letter block 27 in cross-section as it is snapped through a rectangular hole 23 in rim 22 of decorating wheel 10 for use as an impressing/embossing tool. The rim 22 is shown as located inside the slot 31 of the block 27. The nibs on the distal ends of latch extensions 32 snap over the edge of rim 22 at the top and through the edge of rectangular hole 23 at the bottom respectively. In this way, letters can be easily snapped onto, or off, decorating wheel 10 to form a message. This cross-sectional view of the block 27 shows the impressing side 30 of the block 27 and the embossing side 29.

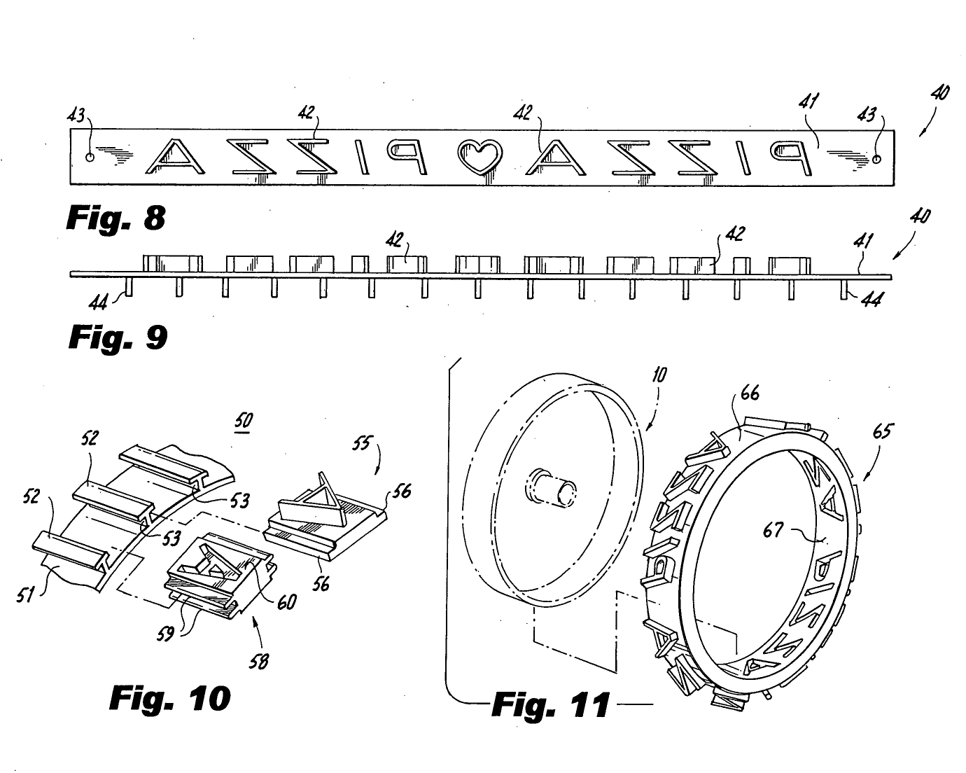

FIG. 8 depicts a top view of a cast or molded flexible message strip 40 having attachment end-hole 43 to allow the message strip 40 to be attached to either embodiment of the device, i.e. a decorating wheel 10 or a decorating stamper 80 (see, FIG. 17). The flexible message strip 40 includes a pre-formed message for convenient use and impressing words down into the food surface or forming raised/embossed words above the general food contact surface. The flexible message strip includes nibs 44, located on the lower surface of the flexible messages strip (not shown), are spaced so as to fit holes 24 on rim 22 of wheel 10. A spring clip retains the flexible message strip 40 through holes 43, and holes 24 of the decorating wheel 10 retain the flexible message strip 40 while it is in use. The flexible message strip 40 is removable and interchangeable with other message strips.

Referring to FIG. 9, a side view of the flexible message strip 40 is show having cast or molded, permanent message affixed thereon. The flexible message strip includes fasteners, such as nibs 44, located on the lower surface of the flexible messages strip, shown in a side-view, are spaced so as to fit holes 24 on rim 22 of wheel 10. A further retaining fastener, such as, for example, a spring clip, retains the flexible message strip 40 through holes 43, and holes 24 of the decorating wheel 10 retain the flexible message strip 40 while it is in use. The flexible message strip 40 is removable and interchangeable with other message strips having additional messages.

Referring to FIG. 10, depicts a flexible elastomeric band that fits snugly over the rim 22 of the decorating wheel 10 and includes transverse ribs 52 formed in a “T”—shape having undercut channels 53 on the surface of the decorating wheel 10. The undercut channels 53 allow the blocks to slide therebetween via block flanges 59 of a double-sided letter block 58 or via a single block flange 56 of a single sided letter block 55. The band 51 has a set of equally spaced transverse ribs 52 with undercut channels 53. The transverse ribs 52 form pockets for receiving either letter blocks 55 or 58. One-sided block 55 has an embossing or impressing format on only the top surface, and flanges 56 fit into channels 53. The double sided blocks 58 have an impressing side 60 on one side and an embossing side on the opposite surface. A slot 61 accommodates rim 22 as well as the thickness of band 51. The top pair of flanges 59 of block 58 can engage channels 53. In this manner, letter block 58 are easily attached and interchanged on to the band 51, to produce messages and images for any occasion on the surface of a food. Alternatively, in yet another embodiment, a decorating wheel having transverse ribs 52 may be used, rather than a band 51, to attach the letter block 55 or 58 to form images in food surfaces.

Referring to FIG. 11, an alternative message embodiment is depicted as a double sided, or single sided, elastomeric band 65. The band 65 is tightly stretched or slid over rim 22 of decorating wheel 10 and remains in place during use. A pre-formed message is molded or cast on one side to impress a message 66 into a food surface and, when the band 65 is inverted to expose the opposite side and message, a message can be formed which may include the same words in a different form, i.e. embossing rather than impressing, than the opposite band side or an entirely new message may be present. In an alternative embodiment, the band 65 may form embossing images on the food surface. A band 65 has pre-set, frequently-used words or messages permanently formed on the band for convenient and can easily slide on to a decorating wheel 10 as needed without individually attaching each block 27. The bands 65 may be formed of a food compatible, flexible material or combination of materials, such as, for example, plastics, silicone, rubbers, elastomers and the like.

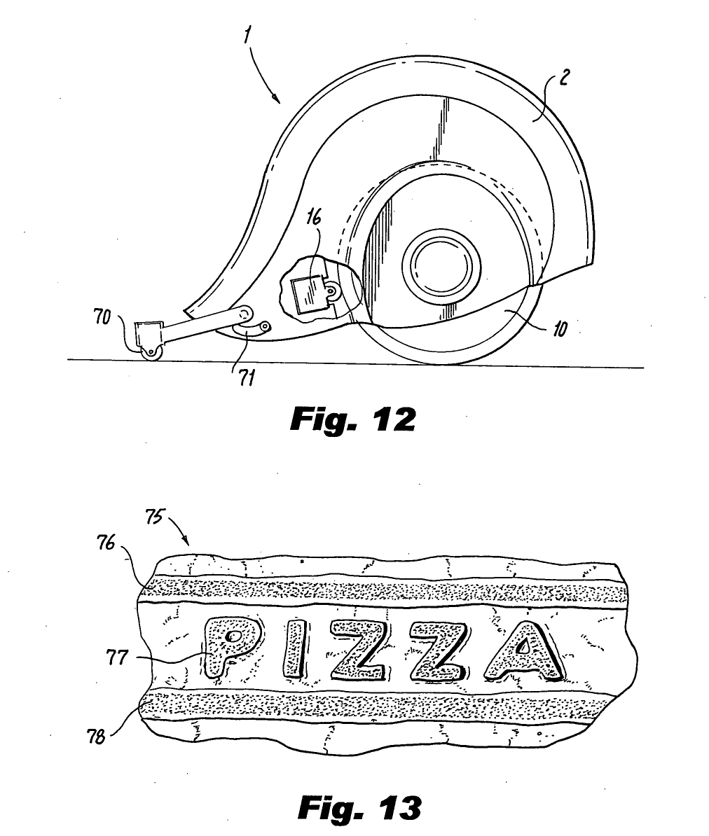

Referring to FIG. 12, a side schematic view of FIG. 12 shows two possible positions for coloring substances and/or oil transferring rollers with reservoirs or coloring cartridge module with respect to the housing 18. A single-wide wheel 16, which is capable of transferring color substances that are acceptable for use with foods, deposits an area of coloring substance onto the decorating wheel 10. The coloring substance is deposited on the decorating wheel 10 and any block 27, message strips 40, or band 65 located on the decorating wheel 10. The coloring substance is then transferred onto the food surface as the decorating wheel 10 is moved over the food surface to impress or emboss images. Where two narrow wheels 16 with a space between are used in position 16 with separate reservoirs, two stripes of different colors can be applied on either side of a message. A third, narrow wheel 70 can be cantilevered from housing 18 and used on an /impressed/embossed message to add further coloring substances. A third wheel 70 can be adjusted in height via an adjuster 71 to color enhance only the highest raised portions of embossed letters or the food surface surrounding impressed letters. As shown in FIG. 13, a tri-colored decoration can be made in this manner by using three different wheels. The two stripes 76 and 78, upper and lower, respectively, can be deposited by narrow dual wheels 16, and followed by decorating wheel 70 which can color the message in a third color, if desired. The coloring wheels can enhance the food work surface for a finished surface having a rainbow or stripe effect in any combination. This coloring effect may be used to enhance an impressed or embossed message according to the holiday or occasion at hand, making the food more appealing to its audience and more unique for a food merchant's sales.

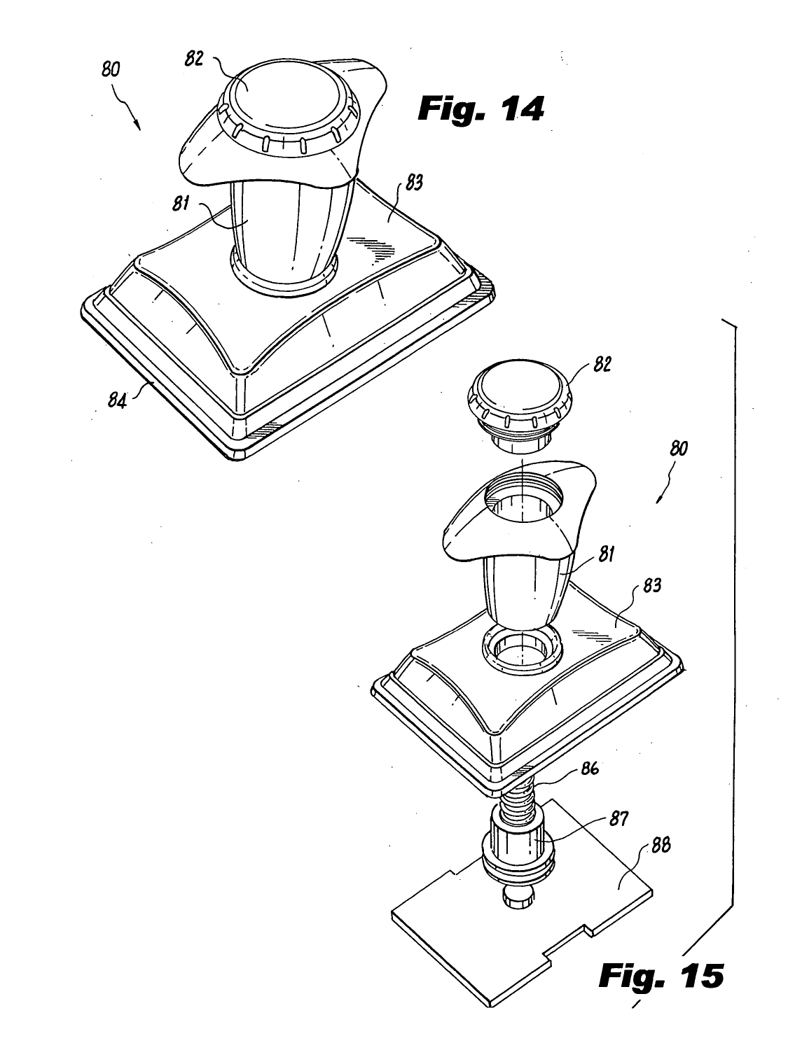

In FIG. 14 is shown yet another embodiment of the food impressing/embossing device which can impress messages, words and images into or onto a food surface, as desired by the user, by employing the interchangeable indicia, such as letter blocks 27 and/or message strips 40. The depicted decorating stamper embodiment 80, is formed of a durable material and acts as a carrier for image-producing letter blocks, message band and message strips, includes a handle 81 for ergonomic ease of use, depth adjuster knob 82 to accommodate the many different types and consistency of food surfaces to be impressed or embossed, a housing 83 for lightweight, easy handling by the user and a base ring 84 which covers and protects the lower portion of the housing 83. By temporarily removing the base ring 84, the exposed lower portion of the housing 83 can frame and cut through the food work surface around any impressed or embossed message or image.

Referring to FIG. 15, an exploded view showing the decorating stamper embodiment of the device, depicting the typical components of the decorating stamper embodiment. The decorating stamper includes a generally rectangular housing 83 having at least an upper and lower surface; a handle portion 81 attached to an upper surface of the housing; a depth adjuster knob 82 attached to an upper portion of the handle portion 81; an engaging column 87 attached to a lower portion of the housing 83; a spring 86 attached to the engaging column 87; and a message plate 88 attached to the lower portion of the housing 83 via the engaging column 87. The message plate 88, which can accept and removably attach blocks 27 and message strips 40 or may have a pre-formed message molded or cast on an interchangeable message plates 88. The message plate 88 is pressed into contact with the food contact surface to form the desired message and may be repeatedly brought into contact with the food surface to a multitude of possible patterns.

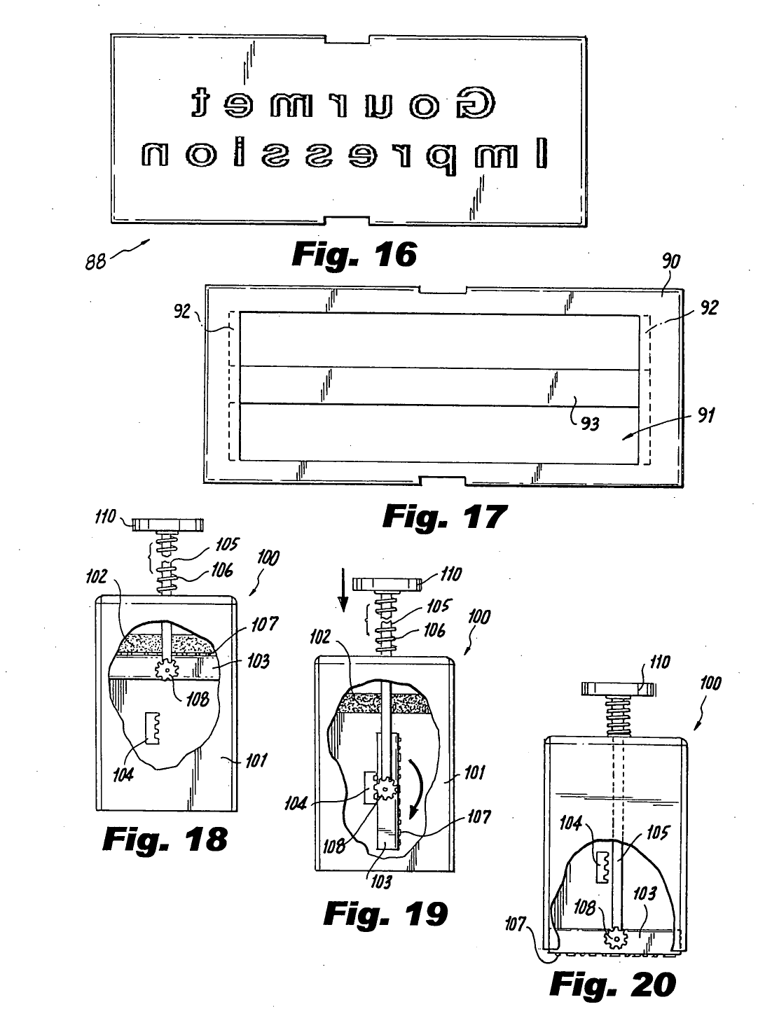

FIG. 16 depicts a view of a cast message plate 88 having a pre-formed message which might be frequently or commonly used to form either impressed or embossed messages into a food surface. Such a message plate 88 is readily interchangeable and other message plates include those that accept blocks 27 and message strips 40 to provide an infinite variety of message available for any commercial and home-use requirements. A decorating stamper embodiment may be combined with blocks 27, message plates 88 and flexible message strips 40 to form a kit. Alternatively, a kit may be combined having a decorating wheel 10 along with blocks 27, message plates 88, flexible message strips 40 and any bands 51, and/or 65 to form a kit, with or without a decorating stamper embodiment of the device. Coloring substances can be added to message plate 88 by using a brush or by using a stamping pad similar having edible coloring substances.

Referring to FIG. 17, an alternate embodiment of a message plate 90 is shown. Message plate 90 has a recessed central area 91 and having channels 92 at each shorter-leg of the rectangular message plate 90. The distal ends of spring-like strips 93 (only one is shown for clarity) are attached to the message decorating stamper 90 within the recessed central area 91 via the channels 92. Strips 93 have the same cross-section shape and size as rim 22 of decorating wheel 10 (as shown in FIG. 7). Therefore letter blocks of a letter block kit (portions as shown in FIGS. 4-6) can be assembled over strips 93. Once the desired message is assembled on one or more strips 93, the strips 93 are inserted in recessed central area 91 via channels 92 and messages strips 40 may be similarly inserted into the channels 92. The decorating stamper can then be used on any food surface to customize or decorate the surface for any celebration or occasion. Coloring substances can be added to message plate 88 by using a brush or by using a stamping pad having edible coloring substances.

An alternate embodiment of the decorating stamper embodiment is shown in FIGS. 18, 19 and 20, which depict the functioning of a self-coloring food decorating stamper as configured with an integral food color pad. A rack and pinion mechanism is shown in the schematic sequence of FIGS. 18-20, although any of the mechanisms, suitably enlarged, of self-inking stamping devices can be used as well, such as, for example, those disclosed in U.S. Pat. Nos. 2,312,727 and 4,432,281, which are incorporated herein in their entity.

FIG. 18 depicts a side view schematic of self-coloring decorating stamper 100 in its resting position. A self-coloring decorating stamper includes a housing 101 of durable material; a short gear rack 104 rigidly attached to the housing 101 and a coloring substance pad 102 removably attached to the housing. A message surface 107 is rotatably in contact with the coloring substance pad 102. The spring 106 is biasing the rod 105 in an upward direction. As force is applied to knob 110, the spring 106 is compressed and the rod 105 forces the plate 103 downward. As the force is further applied, the pinion gear 108 which is attached to the plate 103 engages the fixed gear rack 104 causing the plate 103 to turn over as shown in FIG. 19. Further movement downward rotates the message surface 107 facing down before disengagement with the rack 104. Further movement causes contact with food contact surface as shown in FIG. 20. By releasing knob 110, it will be understood that surface 107 can again be rotated upward prior to contacting pad 102.

In an alternative embodiment, the plate 88 of the stamper may have a curved or angled food contact surface to accommodate food of various geometric configurations, such as spheres, hemispheres, pyramids and the like.

It will be appreciated that the blocks of both single and double-sided forms provide an “open frame” or “open architecture”, multiple use choices for any desired pattern. A user may both impress and emboss any word, message or image into any foodstuff easily by changing the block to spell a word or phrase in any language. Such an open format is ideally suited for a kit, in which letter blocks formed to depict various languages and other images may be included with an applicator, such as a decorating wheel or decorating stamper embodiment.

FIG. 21 shows an alternate embodiment of decorating roller wheel 120 with snap-on upper flange 122 and lower section 124 including axle hub, spokes and lower flange.

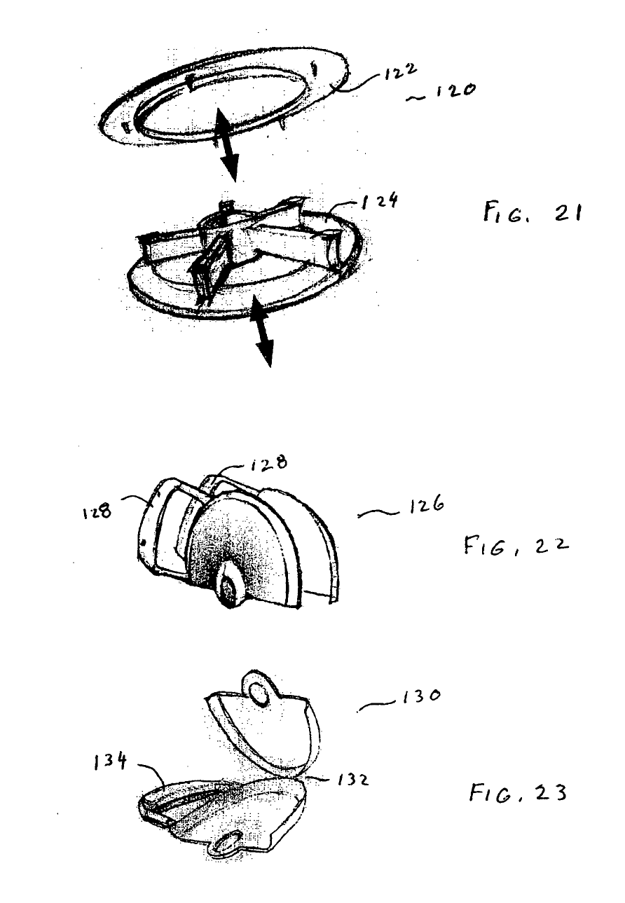

FIGS. 22-25 show four different embodiments of roller housings compatible with decorating wheel 120.

For example, FIG. 22 shows a two-part housing 126 including two snap-together mirror image sections with comfortable extended handle 128, also shown in two parts.

FIG. 23 shows a clam shell version 130 with handle 134 attached to one side and second housing side hinged at 132.

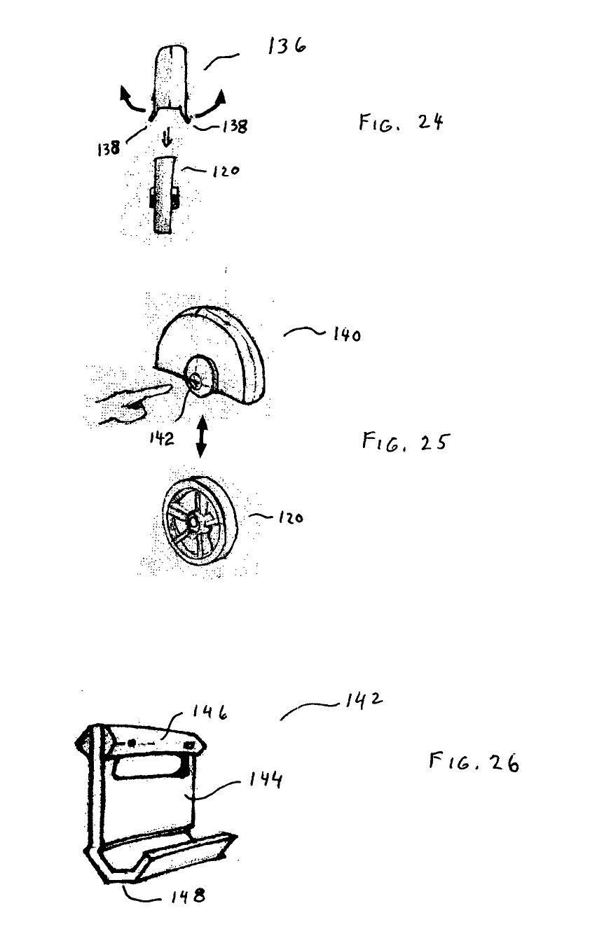

FIG. 24 shows a one-piece housing, with no handle, which attaches and detaches wheel 120 by a snap-in/out motion which momentarily spreads side flange extensions 138 apart.

FIG. 25 shows a one-piece housing 140 with push button 142 operation for attaching and detaching roller wheel 120.

A simple single-line embosser embodiment 142 is shown in FIG. 26. The main body 144 can be either a metal or plastic extrusion that is finished off with the addition of handle halves 146 and access hole below. Surface 148, on which the decorating elements rest, is the stamping surface.

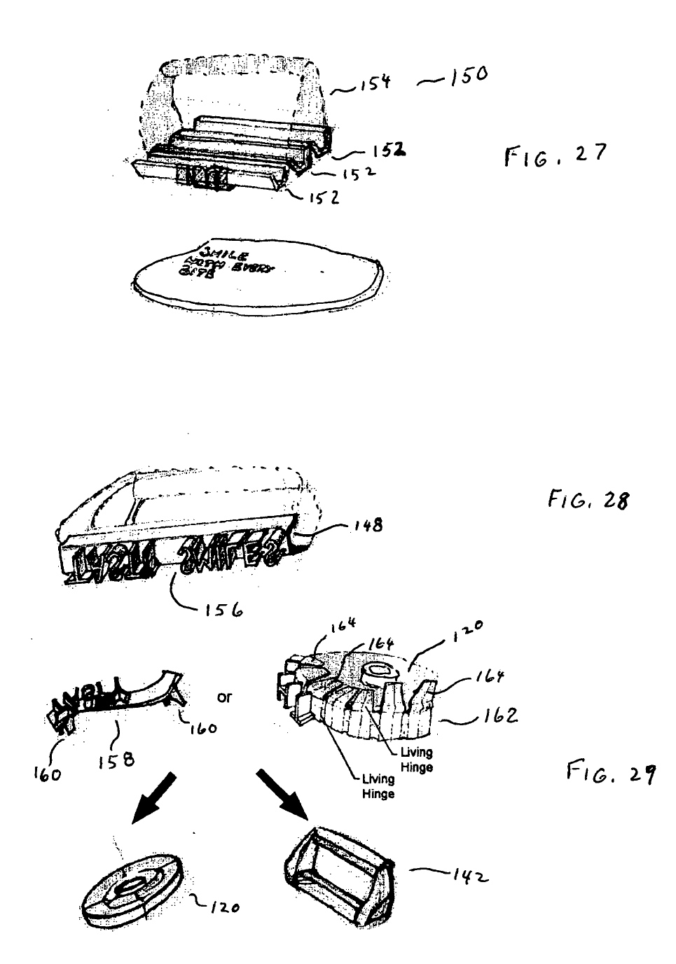

A multi-line stamper 150 capable of stamping multiple lines simultaneously (for example, illustrative only, three lines are illustrated) is shown in FIG. 27. It's construction is similar to that of embosser 142, except for the multiple stamping elements 152 all engaged with handle assembly 154 (show in phantom lines). Stamper 150 can be factory configured for a fixed number of lines, or elements 152 can have features which snap into each other side-by-side so the user can select the number of lines to be assembled.

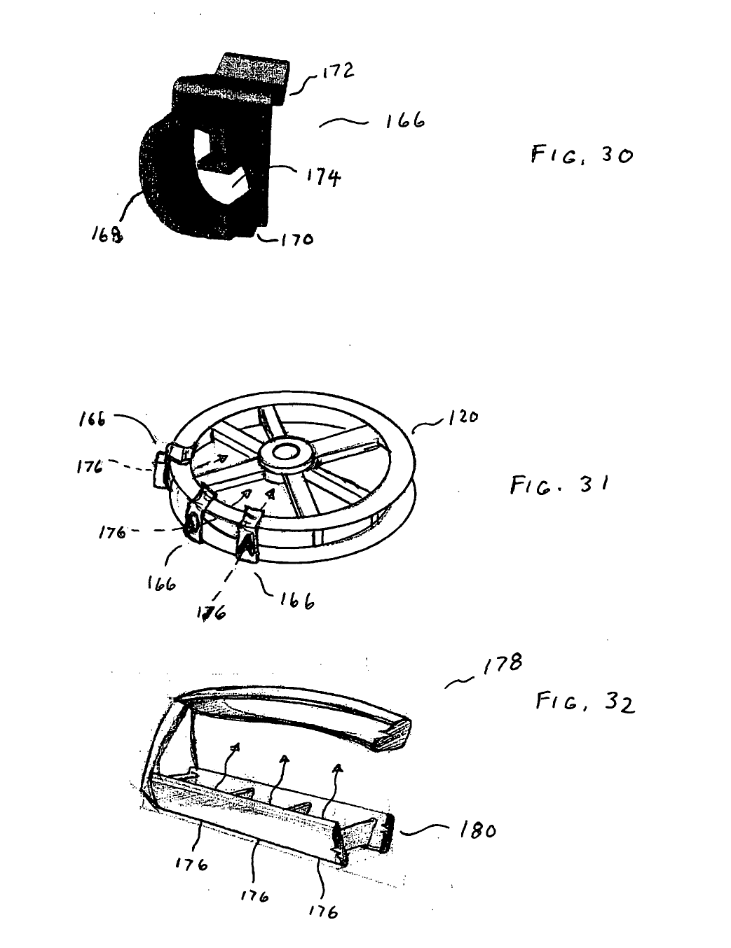

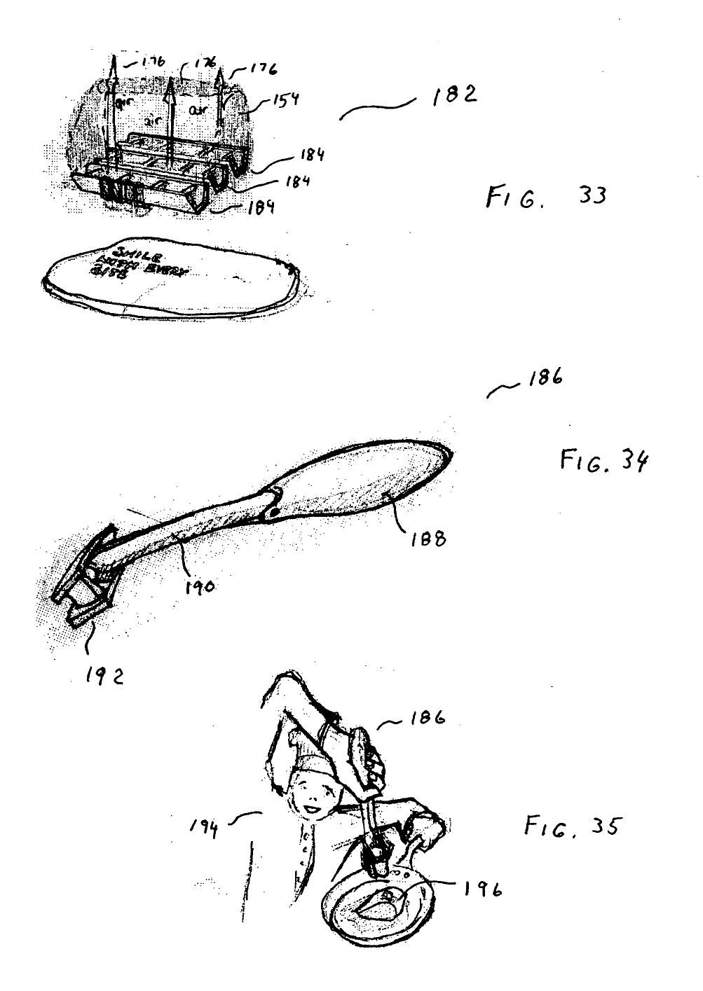

FIG. 28 shows an in-line phrase piece 156 which can be snapped onto surface elements 148 (as shown) or 152 of a stamper. This decorative phrase piece 156 is preferably made of semi-rigid resin, with impression message letters or decorative items protruding from the lower surface.

For illustration purposes, two flexible phrase elements are shown in FIG. 29. These can be used on either decorating roller wheel 120 or on either of stamper surfaces 142 or 150. Phrase element 158 is molded of a flexible material with protruding letters on the front surface and one attachment element 160 adjacent each end, molded onto the back surface. Phrase element 162, in contrast, has regularly attached attachment tabs 164 along the entire length. These are attached on either sides of the imprinting surface by a flexible attachment, such as by a molded living hinge.

FIG. 30 shows an example of vented impression character 166; here a “G” is illustrated. This construction applies to letters with enclosed or semi-enclosed regions. The letter itself, 168, is attached to a frame which has a reciprocal fastener, such as an engagement hook 170, at one end and a closure, such as latch element 172 at the opposite end. Note the vent opening 174.

FIG. 31 shows three such letters 166 attached to decorating roller wheel 120. The open space behind openings 174 permits any accumulated debris to be pushed through the opening provided between the flanges of wheel 120, along paths 176. This debris venting also defeats the piston and cylinder behavior of unvented letters with enclosed regions in some food items; this behavior tends to distort some of the impressions.

To permit the vented letters to operate with their intended advantages on stampers, vented single-line stamper 178, with spaced-apart base sections 180, is shown in FIG. 32.

An optional multi-line vented stamper embodiment 182 with vented bases 184 is shown in FIG. 33. The vented stampers can also be used with phrase element 156 described above.

A hot food decorating wand 186 is shown in FIG. 34. It is used like a branding iron to imprint initials or a logo embossed on the distal end of head 192, which is attached to shaft 190. Insulating handle 188 protects the user from heat that may be transmitted through head 192 and shaft 190, which are typically metal and are contacted with hot food items.

FIG. 35 shows wand 186 in use by chef 194, to imprint an image onto food item 196 cooking in a skillet. The food contact end of head 192 should be highly polished or even coated with a heat resistant coating such as TEFLON® to minimize sticking to food.

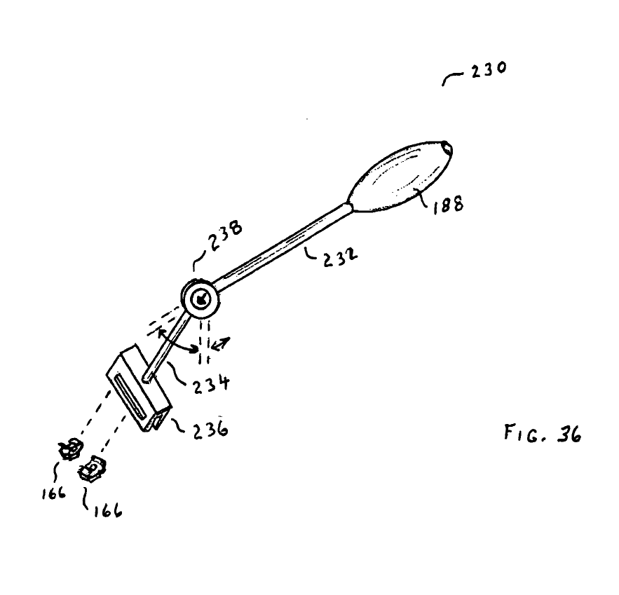

FIG. 36 shows an alternate embodiment of a wand 230 with a hinged head piece 236 feature. Locking hinge 238 has a lock, such as a central push-button release and detents to lock front extension shaft 234 at a variety of angles with respect to shaft 232 to accommodate the convenience of the chef. Additionally, head 236 is configured with spaced apart slots to accommodate snap-on/off letters 166 or any other features (such as decorating phrase pieces) that are compatible with decorating stampers or with a decorating roller wheel. These imprinting/embossing elements must be heat resistant.

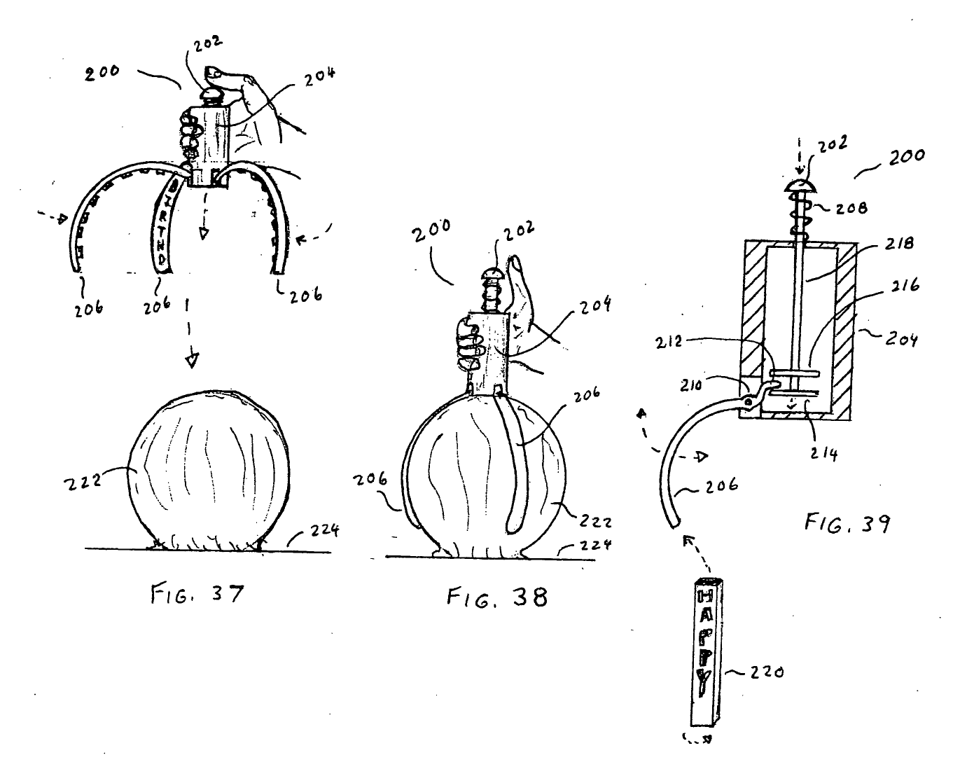

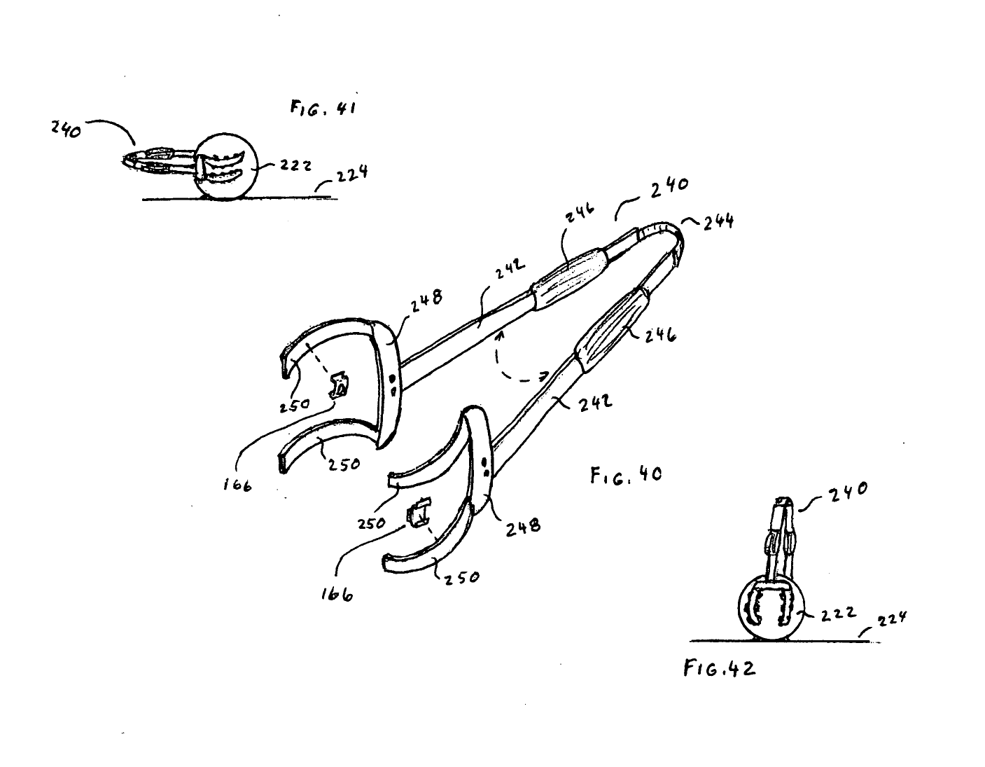

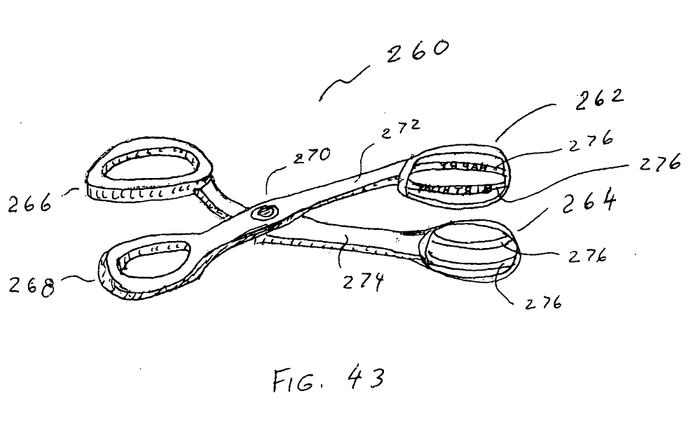

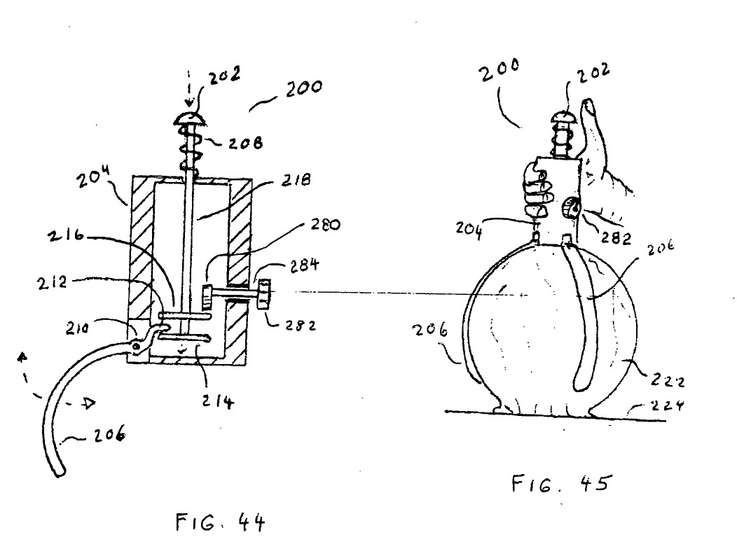

Sets of tongs for imprinting messages or decorating spherical food items are shown in FIGS. 37-39. For illustrative purposes only, three tines, which will result in three longitudinal imprinted or decorated lines, are shown in the illustrations, although four or more tines can also be configured.

FIG. 36 shows sets of tongs 200 above spherical food item 222 which rests on serving surface 224. Tines 206 are in the raised (open) position by virtue of the user's thumb pressing down on actuator, such as a button 202 at the top of housing 204.

In FIG. 37, sets of tongs 200 have been placed on food item 222 and pressure on button 202 has been released. This pivots tines 206 down under spring force in contact with the outer surface of food item 222 thereby imbedding the decorated inner surface of tines 206. Upon re-pressing button 202 and lifting tongs 200 off food item 222, the food item will be imprinted with longitudinal messages each about ⅔ of a semicircle in length (not shown).

FIG. 38 is a detail of the mechanism that controls each of the 3 tines simultaneously. Housing 204 is shown in crossection revealing lower 214 and upper 216 operating disks attached to operating rod 218. Rod 218 is biased upward by spring 208 acting on button 202. Each tine is pivoted 210 on housing 204 and has extension 212 which engages either disk 214 or 216 which determine the position, force, and direction of tines 206. Pressing button 202 down causes tines 206 to rise upward by virtue of disk 216 contacting extension 212. The tines themselves can have indicia, such as raised letters or other images on their inner surface for common occasions such as birthdays or anniversaries. Alternatively, a flexible sleeve 220 with an inner rectangular hole can be slipped onto a each plane tine prior to use. It would have an indicia, such as an image, a phrase or word molded into one surface to be faced inward. Also, separate indicia, such as letters or short designs with elastic loops can be assembled longitudinally onto each tine. Tine size and shape (circular arc size) must be matched to the food item to be imprinted. Removable pivot pins attaching each tine to housing 204 can accommodate a variety of tine sizes.

FIGS. 40-42 illustrate an alternate embodiment for a set of tongs 240 which are configured similar to food serving tongs. Rigid frame side members 242 are attached to crossmembers 248 supporting one or more circular arc tines 250 (four tines are shown in this configuration). Handles 246 provide a better grip although they are optional. A biasing member, such as a U-shaped leaf spring 244, connects two side members 242 while biasing them in the open (spread apart) position. Tines 250 have a crossection compatible with snap-on/off letters 166 or any other logo pieces, or phrase elements usable by the stampers or decorating wheel described above. Note that these sets of tongs 240 can be used either horizontally (FIG. 41) or vertically (FIG. 42) or at any convenient angle at all.

FIG. 43 shows a third embodiment of sets of tongs 260 in the general configuration of scissors with pivot 270, frame members 272 and 274, and handles 266 and 268. Hemispherical imprinting frames 262 and 264 at the distal ends encircle spherical food items and transfer designs or messages attached to letter tracks 276 which accept indicia, such as snap-on letters, images or message strips.

Optional hard stop features for all three embodiments of sets of tongs are illustrated in FIGS. 44-48.

FIGS. 44 and 45 show an adjustable hard stop feature compatible with the first embodiment of sets of tongs. This includes an external knob 282 attached to a disk 280 by a shaft which penetrates housing 204 and is carried in high friction bearing 284. Disk 280 is attached to the shaft off-center forming a cam which can adjustably limit the upstroke of rod 218 by impinging on disk 216. Since it is the spring-operated upstroke that closes tines 206 around the food, the stroke or closure against the food is thereby limited.

FIG. 45 shows the external control knob 282.

Hard stop movement limiting feature 286 is provided, including screw 290 welded or otherwise attached to tong frame at 292 and threaded rod 288 which thus forms an adjustable total length. The screw 290 fit in rod 288 is firm to resist inadvertent rotation.

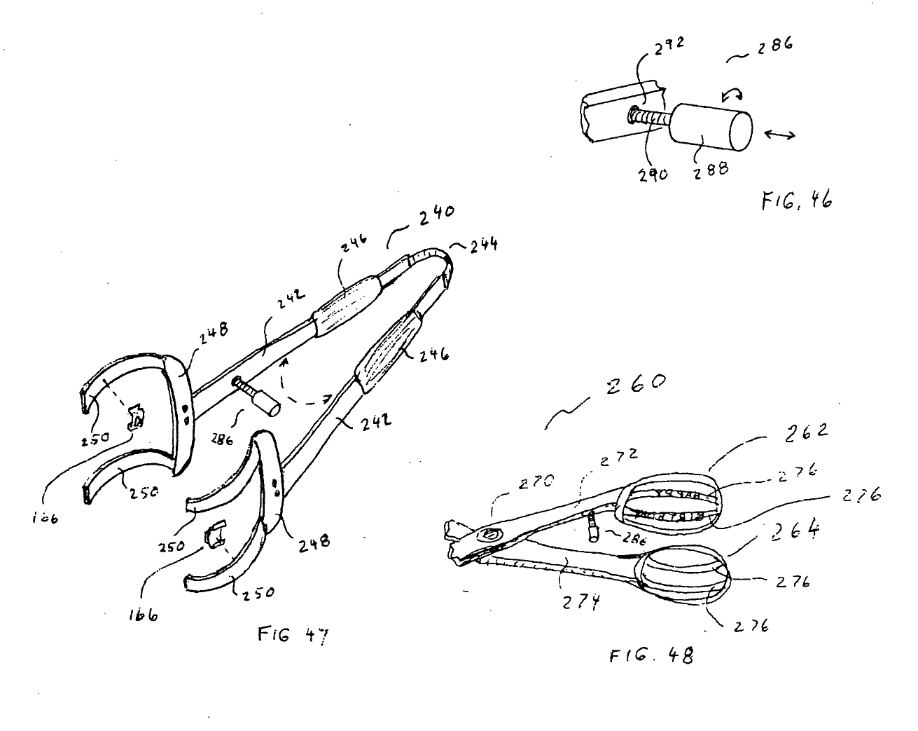

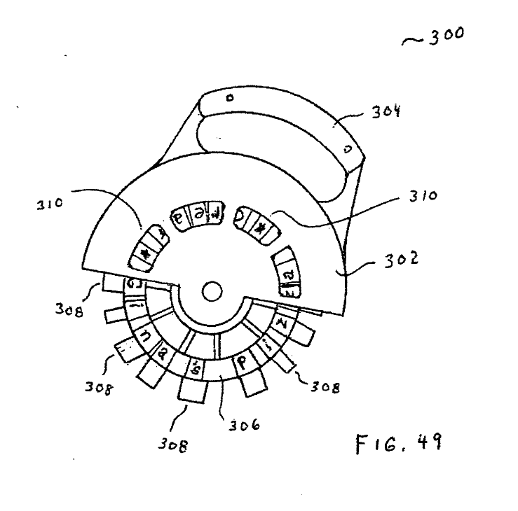

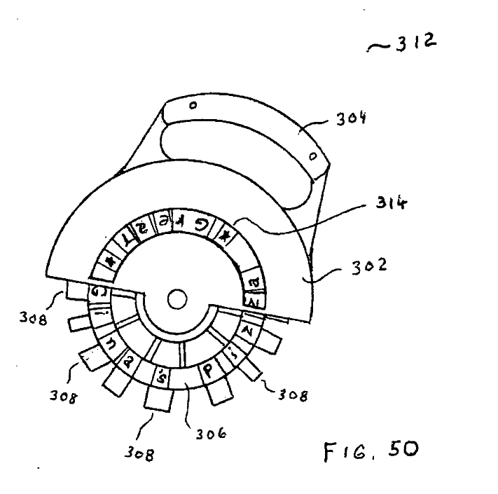

In FIG. 47, operation of feature 286 on sets of tongs of the second embodiment is shown. Rod 288 impinges on the inside frame member 282 to limit closure of tines 250.

In FIG. 48, movement limiting feature 286 is shown attached near the distal end of frame member 272. Rod 288 impinges on frame 274 to limit closure. As a result, soft foods are embossed and/or imprinted without undue mashing of the soft food, thereby permitting legible decorative phrases upon the soft food item.

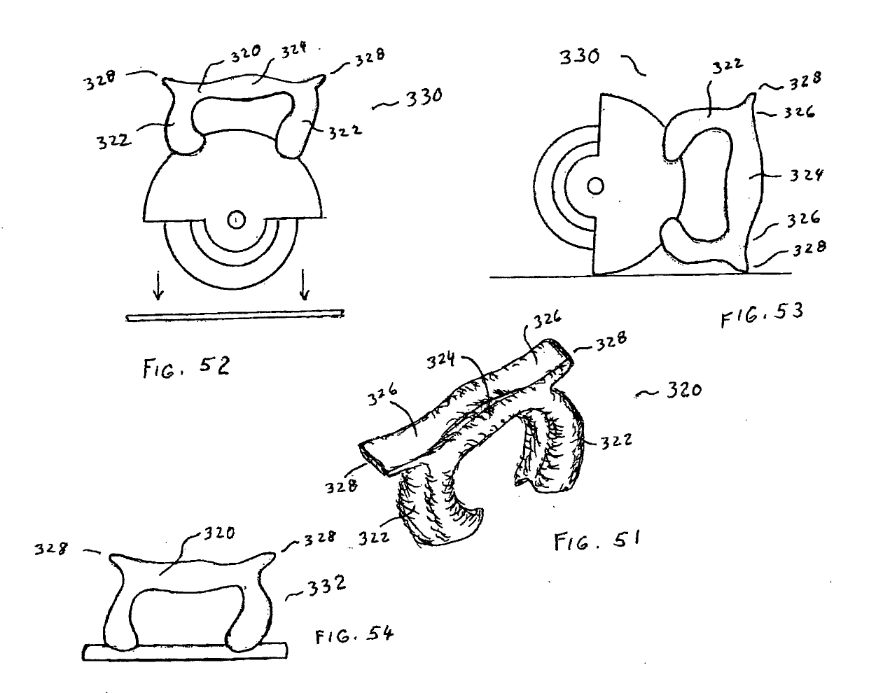

FIG. 49 shows roller 300 which is an embodiment compatible with snap-on letters or symbols 308 with identification printed on their upper side surfaces. Housing 302 with handle 304 is modified with windows 310 in a semicircular array in registration with the identification areas on the side of letters 308 on wheel 306. Although four windows 310 are illustrated, a single continuous window with or without glazing can be used instead. Obviously, the number of separate windows and the width of the web areas between them are a compromise between identification visibility and rigidity of housing 302. Glazing of a single wide window with a transparent resin such as polycarbonate, can be as strong as a housing with no window, however the window and bonding process incurs some cost. Housing 302 can be totally molded of a transparent resin thereby negating the need for a window area to view the entire 360 degree side of the impression wheel 306.

FIG. 50 shows roller 312 which uses a single wide window 314 on each side of housing 302. Note that virtually all of the identification letters around 360 degrees of wheel 306 can be read without interference.

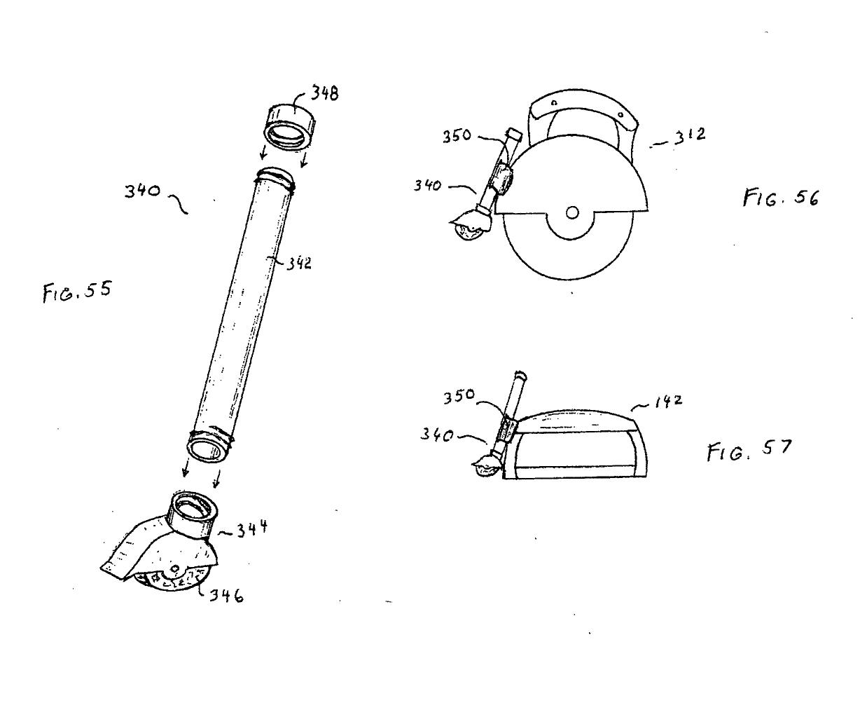

FIGS. 51-54 illustrate an alternate embodiment handle 320 and its use on rollers and stampers of this invention. Handle 320 is comfortably contoured for gripping. It is symmetric front to back with respect to a centerline. Front and rear generally vertical grips 322 would be used for two-handed operation with thumb rest slight depressions 326 above each grip 322. Central horizontal portion 324 is a contoured gripping area for one-handed use. Flat wing ends 328 provide a rest surface for tilting the roller or stamper up on a table top when not in use while keeping the food contact area away from any surface contact.

FIG. 52 shows roller 330 with handle 320 in a position above food to be impressed or imprinted.

FIG. 53 shows the same roller 53 rested on wing end 328 and one edge of its housing.

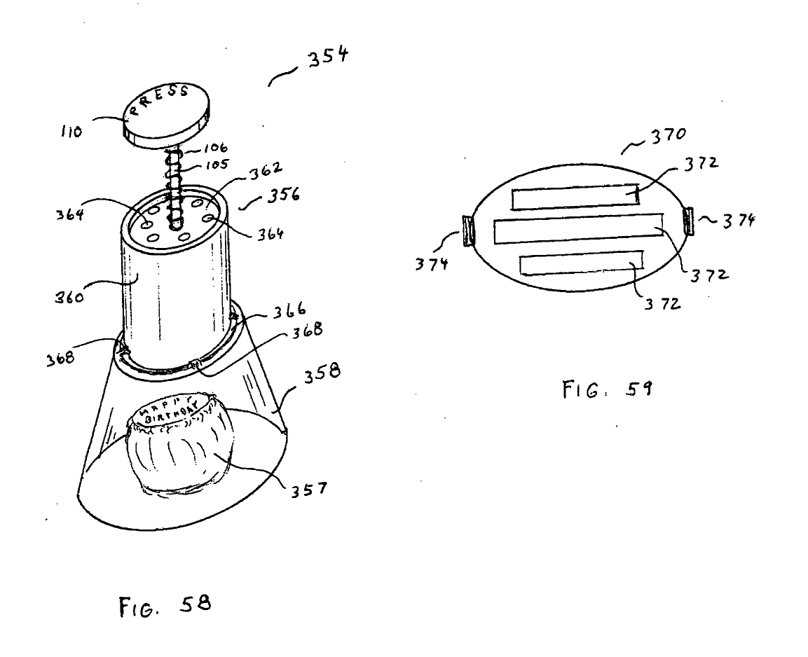

FIG. 54 shows a stamper 332 with handle 320. It too can be tilted up and rested on either wing end 328 when not in use.

Optional coloring tube 340 is shown in exploded view in FIG. 55. It includes reservoir tube 342 with screw-on cap 348 on the top end and a screw-on assembly 344 forming a housing for sponge roller 346 at the bottom end. A rotary “wisk brush” can be substituted for sponge 346. This accessory is conveniently snapped on and off a roller or stamper so that it can be used just prior to rolling or stamping to lay down a stripe of desired fluid item as contained in reservoir 342.

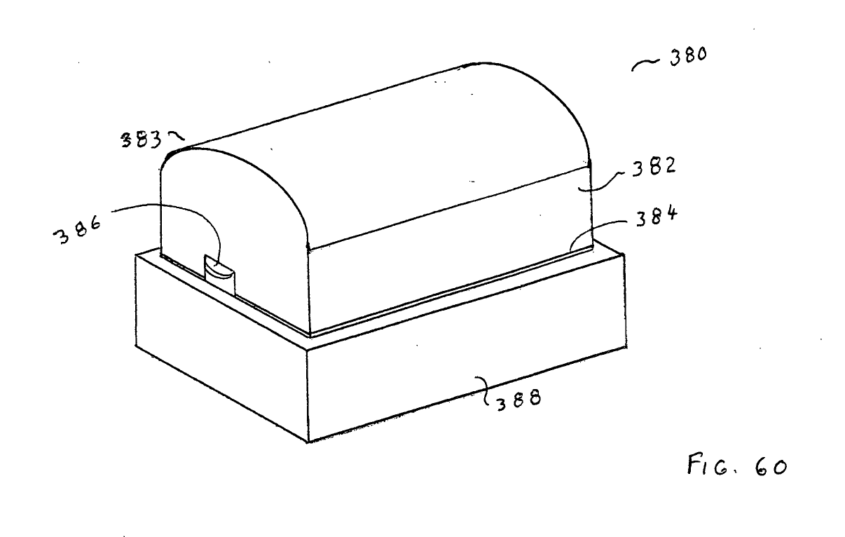

FIG. 56 shows roller 312 with a fastener, such as a spring clip 350 attached to its housing; this retains coloring tube 340 as shown.

Similarly, FIG. 57 shows stamper 142 with spring clip 350 attached to its frame.

FIG. 58 shows a special stamper 354 for imprinting or embossing raised food items of various shapes while at the same time adding liquid or powdered enhancements to the decorated area. This device is called the Crown Me™ tool since it does its job with a single motion atop the food item. Stamper portion 356 has a mechanism that is best described by reference to an earlier larger stamper described by FIGS. 18-20. The housing 360 here is round, but the sponge or porous pad 102, frame 103, inverting gear 108, and stationary rack 104 within are similar. The top of housing 360 has a depressed surface 362 and holes 364 to add the desired items to sponge or porous pad 102 within. The bottom edge of housing 360 has flange 366 which snaps onto and off fasteners, such as spring clips 368 attached to hollow transparent base 358, which contains the food item 357 to be decorated.

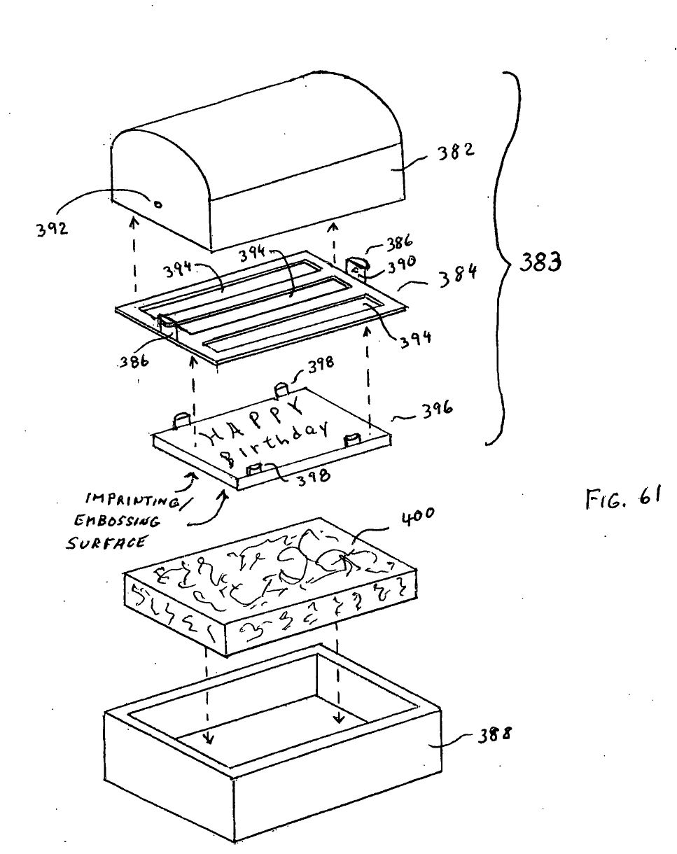

FIG. 59 shows stamper plate 370 which snaps onto or off inverting frame 103 using spring clips 374. Rectangular window areas 372 receive snap-on letters or message plates for imprinting or embossing.

FIG. 60 shows an embodiment of ingredient transferring stamper 380 that avoids the complexity of the “stamping pad” mechanism of the embodiments shown in FIGS. 18-20 and 58. This is more economical to manufacture since inversion of the imprinting/embossing surface is not required.

FIG. 61 shows an exploded view of the components of ingredient transferring stamper 380. The stamper portion itself 383 can be used without added ingredients. It includes a hollow molded housing 382 with base plate 384 which snaps onto housing 382 via spring clip extensions 386 which have protruding nibs 390 snapping into latching holes 392. Rectangular openings 394 (three shown in illustration) in base plate 384 can either accept separate snap-in letters or a message plate 396 as shown which attaches via spring clips 398.

Ingredient container 388 holds sponge or pad 400. It is sized to fit the base plate 384 of stamper 383. In operation, the desired ingredient is added to sponge/pad 400, and then the imprinting surface is touched to pad 400 coating the surface with ingredient which is then transferred to the food item during the imprinting or embossing step. If a depth control as well as ingredient transferring is desired, a combination of an earlier embodiment of stamper shown in FIGS. 14 and 15 with a correctly sized ingredient container 388 can be used instead of using the more simple stamper 383 without depth control.

In the foregoing description, certain terms and visual depictions are used to illustrate the preferred embodiment. However, no unnecessary limitations are to be construed by the terms used or illustrations depicted, beyond what is shown in the prior art, since the terms and illustrations are exemplary only, and are not meant to limit the scope of the present invention.

It is further known that other modifications may be made to the present invention, without departing the scope of the invention, as noted in the appended claims.

What is claimed is:

1. A device for impressing and embossing food surfaces having interchangeable images comprising a heat resistant handle, a housing, a carrier for image-producing letter blocks, message bands and message strips that is removably attached to the housing, a letter block removably attached to the carrier, a message band removably attached to the carrier and a message strip removably attached to the carrier.

2. A device for impressing and embossing food surfaces having interchangeable images comprising a housing, a carrier for image-producing letter blocks, message bands and message strips that is removably attached to the housing, a letter block removably attached to the carrier, a message band removably attached to the carrier and a message strip removably attached to the carrier, wherein the carrier is curved to impress and/or emboss a curvilinear surface.

3. A device for impressing and embossing food surfaces having interchangeable images comprising a housing, a carrier for image-producing letter blocks, message bands and message strips that is removably attached to the housing, a letter block removably attached to the carrier, a message band removably attached to the carrier and a message strip removably attached to the carrier, wherein the carrier is curved to impress and/or emboss a spherical surface.

4. A device for impressing and embossing food surfaces having interchangeable images comprising a housing, a carrier for image-producing letter blocks, message bands and message strips that is removably attached to the housing, a letter block removably attached to the carrier, a message band removably attached to the carrier and a message strip removably attached to the carrier, and a venting means to debris therefrom during the impressing and/or embossing.

5. A device for impressing and embossing food surfaces having interchangeable images comprising a housing, a carrier for image-producing letter blocks, message bands and message strips that is removably attached to the housing, a letter block removably attached to the carrier, a message band removably attached to the carrier and a message strip removably attached to the carrier, wherein the carrier includes a movement stop means to prevent mashing of soft foods.

6. A food impressing device comprising:
a circular housing having an opening on an edge thereof;
an impressing roller wheel extending partially into said housing;
an impressing pattern layer detachably layered over an outer contact surface of said impressing wheel to depress a pattern on a food substrate;
said layer being an interchangeable snap-on layer.

7. The food impressing device of claim 6 in which said housing is formed from a pair of matching segments partially enclosing said embossing wheel.

8. The food impressing device of claim 7 in which each segment has a portion of a handle for said device, each portion coming together to form said handle when said segments are interlocked.

9. The food impressing device of claim 7 in which said segments have a clam shell configuration.

10. The food impressing device of claim 6 in which said housing is of one piece construction and includes means for snapping said wheel in and out of said housing.

11. The food impressing device of claim 6 in which said housing is of one piece construction and includes means for providing push button operation for attaching and detaching said wheel.

12. A line food impressing device comprising a main body with a handle at]one end and a stamping surface formed on an opposite end of said main body.

13. The line food impressing device of claim 12 in which multiple lines of print are formed on said stamping surface.

14. The line food impressing device of claim 13 having means for snapping in and out surface elements forming a message.

15. The line food impressing device of claim 13 in which a surface element is a letter having enclosed and semi-enclosed regions with a vent opening.

16. The food impressing device of claim 6 in which said roller wheel comprises a pair of spaced flanges joined in a hub, said impressing pattern layer being made up of individual letters spanning said spaced flanges, each letter having an opening for permitting debris to be push through into space formed between said flanges.

17. A hot food decorating wand comprising a shaft with a handle on one end and an embossing surface at an opposite end, said embossing surface being provided with a non-stick surface to minimize food sticking to said surface.

18. The hot food decorating wand of claim 17 in which said shaft is articulated, having a locking hinge in a midsection of said shaft for adjusting an angle between upper and lower portions of said shaft.

19. A food impressing device for imprinting messages on spherical food items comprising:
a housing;
a plurality of curved tines extending down from said housing;
means on said housing for urging said curved tines against an outer surface of a spherical food item;
a push button on said housing for raising said tines away from said outer surface of said food item; and
said tines having raised letters on inner surfaces thereof for impressing said letters on said surface of said food item.

20. A food impressing device for imprinting messages on spherical food items comprising:
means joining proximate ends of a pair of first and second tongs;
a distal end of each tong having curved claws, concave surfaces of said claws on the first tong facing concave surfaces of claws on the second tong; and
embossing letters mounted on said concave surfaces.

21. The food impressing device of claim 20 in which said joining means is a spring biasing the distal ends of said tongs apart from each other.

22. The food impressing device of claim 21 having handles mounted on midsections of said tongs.

23. A food impressing device for imprinting messages on spherical food items comprising:
a set of tongs in a scissors configuration with midsections of said tongs crossing each other forming a pivot;
handles formed on proximate ends of said tongs;
embossing frames mounted on distal ends of said tongs, said embossing frames being curved, concave surfaces on each frame facing each other; and
embossing letters mounted on said concave surfaces.

24. The food embossing device as in claim 20 further comprising a means to prevent crushing of soft food, said means comprising an adjustable limit stop, limiting the degree to which respective end effectors of said sets of tongs can close upon a food item, thereby preventing accidentally mashing of the soft food items.

25. The food embossing device as in claim 24 wherein said limit stop means comprises an adjustable cam.

26. The food embossing device as in claim 24 wherein said limit stop means comprises an adjustable threaded cylinder.

27. The food embossing device as in claim 24 wherein said limit stop means comprises an external knob attached to a disk by a shaft which penetrates a housing and is carried in high friction bearing, said disk being attached to said shaft off-center, forming a cam which said cam adjustably limits an upstroke of a rod by impinging on said disk, wherein a spring-operated upstroke closes said tines of said tongs around the soft food, whereby the stroke closure against the soft food is thereby limited.

28. The food embossing device as in claim 24, wherein said limit stop means comprises a threaded member attached to said of said set of tongs and a threaded rod which thus forms an adjustable total length, wherein said threaded member and said rod form a predetermined adjustable length assembly preventing rotation of said set of tongs, said rod impinging on the inside of a frame member of said set of tongs to limit closure of said tines of said set of tongs.

29. The food impressing device as in claim 6 further comprising said housing of said roller being provided with a window revealing indicia on said roller through said window, which said indicia would have been otherwise obscured by respective sides of said housing.

30. The food impressing device as in claim 29 wherein said window is a semicircular window.

31. The food impressing device as in claim 29 wherein said window is a plurality of separate windows in a semicircular array with narrow web areas located therebetween.

32. The food impressing device as in claim 29 wherein said window is a single wide semicircular window with glazing of transparent plastic.

33. The food impressing device as in claim 29 wherein said window comprises said housing being transparent.

34. The food impressing device as in claim 6 further comprising said housing having a resting tab permitting said housing to rest in an upright erect position when not in use.

35. The food impressing device as in claim 6 further comprising a fluid dispensing tube having a tubular reservoir with a dispenser at its lower distal end for spreading fluid from said reservoir onto a food item to be embossed or imprinted.

36. A food impressing device comprising a hollow housing having an internal stamping pad movable by pressure from a manually operable knob external to said housing, said pad contacting an upper surface of the food item within said hollow housing.

37. A food impression device for imprinting messages on a spherical food item comprising:
a housing;
a plurality of curved tines extending down from said housing;
means in said housing for urging said curved tines against an outer surface of said spherical food item;
a push button said housing for actuating said urging means within said housing for urging said tines to make contact with an outer surface of said spherical food item;
said tines having raised letters on inner surfaces thereof for impressing said letters on said surface of said food item; and
a hard stop within said housing for limiting inward movement of said tines to protect against damage to said food item.

38. The device of claim 37 having means outside of said housing to adjust a stopping position of said hard stop.

39. The device of claim 20 having means to limit inward movement of said claws.

40. The device of claim 39 in which said limit means comprises a rod member extending from one of said tongs toward an opposite tong, a distal end of said rod member limiting inward movement of said tongs.

41. The device of claim 40 in which said rod member is threadably adjustable to select a stopping point for said tongs thereby protecting said spherical food item from damage.

42. The device of claim 7 having openings in one of said matching segments for viewing identification areas on a side of said pattern layer.

43. The device of claim 42 in which said openings are glazed.

44. The device of claim 8 in which said handle has flat wing ends having rest surfaces for allowing said device to be placed upright when not in use.

45. The device of claim 12 in which said handle has flat wing ends having rest surfaces for allowing said device to be placed upright when not in use.

46. The device of claim 6 having a coloring tube mounted on an outside surface of said housing, said coloring tube having a closed end and an open end, a roller mounted on said open end, an edible liquid coloring agent within said coloring tube, and said coloring tube oriented so that said roller will lay down a stripe of a desired color prior to rolling over by said impressing wheel.

47. The device of claim 46 in which said roller is a sponge.

48. The device of claim 46 in which said roller is a rotary wisk brush.

49. A food impressing device for imprinting a message with an enhancement on a portion of a food item comprising:
a cylindrical housing with a lower end and an upper end;
the lower end of said of said housing be closed by a slidable stamper plate having windows to receive snap-on members for imprinting said food item;
the upper end having a depressed surface closing said upper end, said depressed surface having openings for depositing enhancing material to a sponge located on an upper surface of said stamper plate;
a flange formed along an edge of said lower end of said housing;
a flared, transparent frusto-conical shaped base extending down from said flange for enclosing said food item on a horizontal surface;
a slidable push rod extending from said stamper plate through said depressed surface out of the upper end of said housing; and
a push button on a top end of said push rod for allowing said rod and stamper plate to be pushed down to contact said food item, imprinting a message on said food item.

50. The device of claim 49 in which a coil spring surrounds said push rod above said upper end of said housing for biasing said push rod into an up position with said stamper plate retracted into said housing.

51. The device of claim 50 in which spring clips attach said base to said flange.

52. A stamper used for stamping at least one food ingredient comprising:
a housing holding an absorbent member containing at least one food ingredient;
a stamper member contacting said absorbent member thereby transferring said at least one food ingredient onto an embossing/imprinting surface prior to contacting the food item;
said hollow housing having a snap-on base plate with a plurality of openings which can accept at least one of a message plate or at least one snap-in letter.
